(19) United States
(12) Patent Application Publication
(10) Pub. No.: US 2026/0155058 A1
(43) Pub. Date: Jun. 4, 2026

(54) Artificial Intelligence Tutor Based Personalized and Real-Time Guidance System for Online Learning Sessions

(71) Applicant: 2hr Learning, Inc., Austin, TX (US)

(72) Inventors: Philip Hewinson, Woking (GB); Samy Aboel-Nil, Austin, TX (US); Shawn Sullivan, Seattle, WA (US)

(73) Assignee: 2hr Learning, Inc., Austin, TX (US)

(21) Appl. No.: 19/269,934

(22) Filed: Jul. 15, 2025

Related U.S. Application Data
(60) Provisional application No. 63/671,743, filed on Jul. 15, 2024.

(51) Int. Cl. G09B 5/06; G06V 40/20; G10L 15/18; G10L 25/63

(52) U.S. Cl. CPC G09B 5/065; G06V 40/20; G10L 15/1822; G10L 25/63

(57) ABSTRACT

A system and method combine programmatic control and a guided and constrained Artificial Intelligence (AI) engine provide real-time tutors in an online learning platform to enable the AI tutors to interact with the user and relevantly respond to user queries. The method includes receiving a request from the user for guidance during an online learning session or practice test via an interactive button on the user interface. The AI engine then accesses the user profile and educational database using a collector, gathering details of ongoing and past sessions, performance data, and interaction data. Utilizing this information, a prompt generator creates prompts to direct the AI engine, which then produces a detailed, personalized response. This response is generated in correlation to the context of the learning session and user data, explains concepts, corrects misunderstandings, and provides guidance, enhancing the educational experience for the user.

### CROSS-REFERENCE TO RELATED APPLICATION(S)

This application claims the benefit under 35 U.S.C. § 119(e) and 37 C.F.R. § 1.78 of U.S. Provisional Application No. 63/671,743, which is incorporated by reference in its entirety.

### FIELD OF THE INVENTION

The present invention relates in general to the field of electronics, and more specifically to the interaction of an AI (Artificial Intelligence) generated real-time tutor and the user using an online learning platform when the user needs any guidance for the questions asked during the tests or when the user faces difficulty in understanding the concepts while studying the educational content.

### BACKGROUND OF THE INVENTION

In recent years, the integration of technology, especially the use of Artificial Intelligence (AI) in the field of education has increased to a great extent. AI has the potential to enhance the learning experience, personalize instructions, and provide valuable insights to both educators and well as students.

In the earlier days, students have traditionally sought help through various methods, each with its own set of limitations. Scheduled tutoring sessions, for instance, are not always available on demand. This can lead to delays in getting assistance when it is needed the most. Moreover, these sessions may not offer immediate feedback, which is crucial for learning effectively at the moment. Asynchronous communication with tutors, such as email exchanges, is another common alternative. However, the lack of immediate responses can hinder the learning process, and the absence of real-time interaction often results in a less personalized experience.

Static educational resources like textbooks and pre-recorded videos are widely used, but they fail to provide interactive guidance concerning the student's specific challenges. These resources also do not fully adapt to unique learning pace and style of users, thus have limited effectiveness.

Traditional classroom learning, while valuable, also has its drawbacks. It offers limited opportunities for immediate, personalized feedback and may not provide effective learning styles to everybody. Similarly, non-interactive study guides lack the capability to engage students in a dialogue and do not provide real-time, personalized assistance. Online forums and discussion boards offer a platform for students to seek help from peers and educators. However, the responses may not be immediate and the quality of feedback can vary.

Alternative methods to real-time, personalized educational support include traditional tutoring services and online learning platforms. However, these services often do not provide immediate responses and require scheduling. They also lack the deep personalization and curriculum integration. Chat-based tutoring services and educational forums allow students to ask questions and receive guidance, but they may not offer real-time interaction or the targeted, contextually relevant responses.

Conventionally, students seeking help with study material or practice tests rely on scheduled tutoring sessions, which might not align with the students immediate need for clarification, leading to potential delays in understanding and knowledge retention. The conventional approach often lacks the ability to provide real-time, personalized feedback, which is crucial for adapting to a student's unique learning pace and style.

### SUMMARY

In at least one embodiment, a method of guiding and constraining an artificial intelligence (AI) engine allows a virtual character to interact with a user using an online learning platform. Guiding the user includes executing code using one or more processors of a computer system to cause the computer system to perform operations. Operations include receiving a request from the user asking for guidance during an online learning session or in between practice tests. Operations include accessing a user profile and educational database to fetch details of the user and educational content items. User details include details of ongoing and past online learning sessions, user performance data, and user interaction data with the online learning platform. Operations include generating a prompt to guide and constrain the AI engine for guiding the user based on a context of the ongoing learning session, user interactions with the online learning platform, and user performance data. Operations include transferring the generated prompt to the AI engine. Operations include receiving a detailed and personalized response from the AI engine. The response explains educational concepts, corrects any user misunderstanding of the educational concepts, and guides the user in correlation with the educational database.

In at least one embodiment, a system to guide and constrain an artificial intelligence (AI) engine enables a virtual character to interact with a user using an online learning platform for assisting in educating the user. The system includes one or more processors and a memory, coupled to the one or more processors, that stores code that when executed causes the one or more processors to perform operations. The operations include receiving a request from the user asking for guidance during an online learning session, or in between the practice tests using an interactive button integrated within a user interface of the online learning platform and accessing user profile and educational database to fetch the details of the user and educational content items using a collector, wherein the user details include details of the ongoing and past online learning sessions, user performance data, and user interaction data with the online learning platform. The operations further included generating a prompt using a prompt generator to guide and constrain the AI engine for guiding the user based on the context of the ongoing learning session, user interactions with the online learning platform, and user performance data, transferring the prompt generated by the prompt generator to the AI engine to guide the user; and receiving a detailed and personalized response from the AI engine, wherein the response explains educational concepts, corrects any user misunderstanding of the educational concepts, and guides the user in correlation with the educational database.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary user guidance system using real-time tutors in an online learning platform.

FIG. 2 depicts an exemplary user guidance process using real-time tutors in an online learning platform.

FIG. 3 depicts a flowchart showing the steps to guide the user via a real-time tutor using an online learning platform.

FIG. 4 depicts an exemplary user interface displaying the front page of the study mode operation in an online learning platform.

FIG. 5 depicts an exemplary user interface displaying the details of the unit that the user has to study during an online learning session.

FIG. 6 depicts an exemplary user interface displaying the educational content items to the user.

FIG. 7 depicts an exemplary user interface disclosing the appearance of a real-time tutor to guide the user when the user has given the incorrect answer.

FIGS. 8-11 depict exemplary user interfaces disclosing the interaction between the user and a real-time tutor.

FIG. 12 depicts an exemplary user interface displaying the front page of the practice test mode operation in an online learning platform.

FIGS. 13 and 14 depict exemplary user interfaces disclosing the educational content to the user where the user gives correct and incorrect answers respectively.

FIGS. 15 and 16 depict exemplary user interfaces disclosing the interaction between the user and a real-time tutor.

FIG. 17 depicts a response generation process for guiding the user using a real-time tutor, which is an embodiment of the user guidance process using real-time tutors in an online learning platform of FIG. 2.

FIG. 18 depicts a personalized response generation process based on the analysis of the student's performance, which is an embodiment of the user guidance process using real-time tutors in an online learning platform of FIG. 2.

FIG. 19 depicts a student and real-time tutor interaction process, which is an embodiment of the user guidance process using real-time tutors in an online learning platform of FIG. 2.

FIG. 20 depicts a response delivery process, which is an embodiment of the user guidance process using real-time tutors in an online learning platform of FIG. 2.

FIG. 21 depicts a data structure for organizing data to provide real-time, in-context, and personalized educational guidance to the user using an online learning platform.

FIG. 22 depicts a data structure for organizing data to allow real-time interaction between a user and a real-time tutor.

FIG. 23 depicts a data structure for organizing data to generate a response and provide it to the user through a real-time tutor.

FIG. 24 depicts a data structure for organizing data to disclose the application areas of the user guidance system using real-time tutors.

FIG. 25 depicts an exemplary network environment in which the system of FIG. 1 and the process of FIG. 2 may be practiced.

FIG. 26 depicts an exemplary computer system.

### DETAILED DESCRIPTION

The user guidance system and method set forth herein address technical issues to allow users to interact with the real-time tutors described herein. Conventionally, manual processes were used to allow users to interact with the real-time tutors and were very tedious and time consuming. The present user guidance system and method utilize an automated system that does not merely automate a manual process or use a conventional system in a conventional way. The present user guidance system and method utilize one or more artificial intelligence (AI) engines and integrate programmatic process management to technologically guide and constrain the one or more AI engines to allow users to interact with the real-time tutors in a completely different way than both any manual process and different than normal use of programs and AI engines. Utilizing specially engineered guidance and control to direct an AI system in solving the technical problems presented below, which require a technical solution. The user guidance system and method described below are not simply engaging a computer to carry out conventional mental processes, but rather change how computers (and AI systems, specifically) operate to achieve the generation results that were not previously possible or were substantially inefficient prior to the user guidance system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the user guidance system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The user guidance system and method generate decomposed, technically engineered AI prompts to include selected and integral AI engine guidance and constraints. The technically engineered prompts are generated and guided with programmatic, automatic inputs specifically designed to unconventionally guide and constrain an AI engine to allow users to interact with the real-time tutors, perform quality control to retain or automatically discard outputs that do not meet guidance and constraints, and make the desired outputs available for use, such as use by computer system applications. In at least one embodiment, the problem to be solved by the integrated programmatic and AI engine user guidance system and method is uniquely and unconventionally decomposed, and AI prompts are used to solve the decomposed problem. Furthermore, the programmatic inputs to the decomposed AI prompts provide guidance to allow users to interact with the real-time tutors.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the user guidance system and method described herein. Thus, the present user guidance system and method described implement an integration of programmatic management over decomposed prompts with engineered AI engine guidance and constraints to affect an improvement in AI, programmatic AI management, and AI integrated with programmatic management technology. The present user guidance system and method allow computer systems to include programmatic management, one or more AI engines, and one or more data sources to allow users to interact with the real-time tutors, whenever the user provides an incorrect answer, faces difficulty in understanding the concepts of the educational content displayed to the user, or wants to gain extra knowledge on the corresponding educational content that previously could not be produced with conventionally prompted AI engines or could only be produced by humans utilizing a completely different, time consuming, and tedious process. The user guidance system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models-Algorithms that analyze data, recognize patterns, and make predictions.
2. Neural Networks-Deep learning architectures that mimic the human brain for tasks like image and speech recognition.
3. Data Processing Module-Handles raw data input, transformation, and feature extraction.
4. Inference Engine-Applies trained models to make real-time decisions based on new data.
5. Optimization Algorithms-Improves model efficiency, reducing errors and improving predictions.
6. Natural Language Processing (NLP) Module-Enables AI engines to understand, interpret, and generate human language (e.g., chatbots, voice assistants).
7. Computer Vision Module-Allows AI to interpret and analyze images or videos.
8. Reinforcement Learning Mechanism-Helps AI learn from trial and error, optimizing performance over time.
9. API Interface-Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

Notwithstanding any provision to the contrary or anything to the contrary in the below pages, the below pages are not limiting and do not describe all embodiments of the user guidance systems and methods. For example, use of the term “invention” does not limit or require the referenced certain features to be present in all embodiments of the invention. Use of absolute-type terms, such as “required,” “must,” “only,” “important,” and so on are not limiting of all embodiments of the user guidance systems and methods and not to be construed as limiting of the embodiments of the user guidance systems and methods described above.

A user guidance system using real-time tutors in an online learning platform to guide an AI (Artificial Intelligence) engine to allow users to interact with the real-time tutors, whenever the user provides an incorrect answer, faces difficulty in understanding the concepts of the educational content displayed to the user, or wants to gain extra knowledge on the corresponding educational content is disclosed herein. The online learning platform having an integrated user interface includes an interactive button (also known as, ‘Raise Hand button). The user clicks on the interactive button in case of any queries related to the educational content presented via the user interface during an online learning session. Upon clicking the button, a real-time tutor pops-up on the user interface and explains the concepts related to the contextual educational topic. The real-time tutor explains the concept through a pre-generated video displayed via the user interface. The user can interact with the real-time tutor till the doubts related to the topic are clear.

The online learning platform is operatively coupled to a user guidance engine configured to access and analyze the user data to generate prompts for guiding the AI engine. The user guidance engine includes a user data manager to access user data stored in memory of the online learning platform. To accomplish this, the user data manager includes a collector configured to retrieve user profile data, user performance data, user interaction data, and details of the current and past online learning sessions from the memory. The collected data is analyzed using an analyzer, based on which a prompt generator generates prompts that are further transferred to an AI engine. A prompt structure along with the rules and guidelines to write the prompt is provided to the prompt generator by a prompt engineer. The AI engine generates a response to guide the user on the educational topic.

The user guidance system enhances online learning by providing real-time, personalized tutoring using advanced natural language processing (NLP) and AI. When a user requests help from the online learning platform or faces difficulty in understanding a concept, the user guidance system utilizes a personalized approach to guide the user is a contextually relevant manner that addresses challenges in understanding the underlined topic. By automating the guidance process, the user guidance system not only engages with users more effectively but scales to meet the needs of a larger user base without compromising on the quality of support. Consequently, this leads to better educational outcomes by offering consistent, immediate, and personalized assistance, making high-quality education more accessible and efficient.

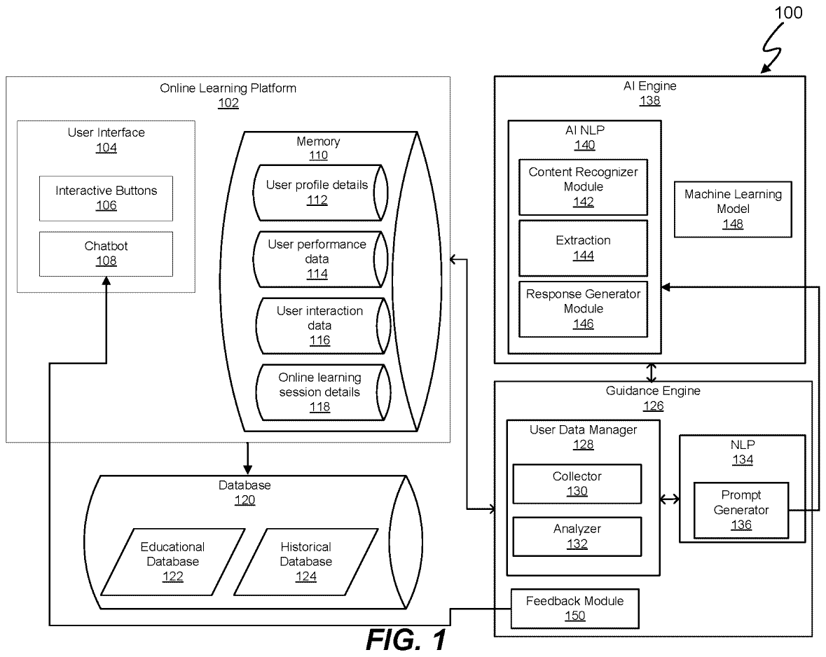

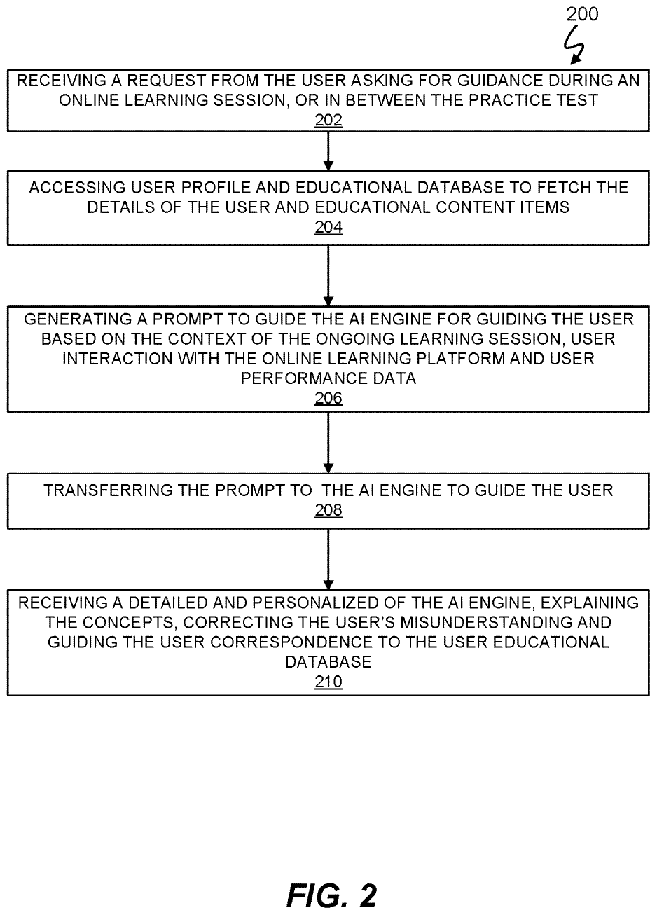

FIG. 1 depicts an exemplary user guidance system 100 using real-time tutors in an online learning platform 102. FIG. 2 depicts an exemplary user guidance process 200 using real-time tutors in an online learning platform 102 utilized by the user guidance system 100.

Referring to FIGS. 1 and 2, in operation 202, a request is received from the user asking for guidance during an online learning session, or between the practice tests using an interactive button 106 integrated within a user interface 104 of the online learning platform 102.

When a user seeks guidance during an online learning session or while taking practice tests, they initiate the user guidance process 200 by tapping an interactive button 106 integrated within the user interface 104 of the online learning platform 102. The interactive button 106, is integrated within the user interface 104 of the online learning platform 102 to ensure easy accessibility to the user. Upon activation, the user guidance system 100 promptly registers the user's request and passes the request to a user guidance engine 126, operatively coupled to the online learning platform 102. The interactive button 106 acts as a bridge between the online learning platform 102 and the user guidance engine 126, ensuring that the request is seamlessly captured and processed. By utilizing this feature, the online learning platform 102 effectively addresses user's immediate needs, thereby providing a more interactive and supportive educational environment.

The codes and functions mentioned in the pseudo-code of the user guidance system 100 using real-time tutors in an online learning platform 102 to raise hand and fetch content are explained below in correlation to the above mentioned details.

The Raise Hand function, ‘raiseHand(student_id, content_id)’, serves as the primary function enabling users to request help. When the user raises their hand, the collector 130 first retrieves the current context of the user's study material by calling ‘getContext(student_id, content_id)’.

The Get Context function, ‘getContext(student_id, content_id)’, collects the necessary background information about the user's interaction with the study material. It accesses the educational database 122 to retrieve the user's interaction history and the details of the content they are studying. This information is combined to form a comprehensive context, which is then returned to be used in generating an AI response. This context includes previous interactions and specific content details that are relevant to the current query. The Get Historical Figure function, ‘getHistoricalFigure(content_id)’, retrieves the historical figure associated with a particular piece of content from the historical database 124. This figure is intended to provide a personalized and engaging way of delivering responses to the user, utilizing AI-animated historical figures as real-time tutors.

In operation 204, a user data manager 128 accesses user profile details 112 and educational database 122 to fetch the details of the user and educational content items using a collector 130, integrated within the user data manager 128. The user details include details of the ongoing and past online learning sessions 118, user performance data 114, and user interaction data 116 with the online learning platform 102. The education database 122 includes a plurality of educational content items categorized by the standard, topic, and difficulty level.

The user guidance engine 126 includes a user data manager 128, which further includes a collector 130 and an analyzer 132. The collector 130 accesses and retrieves user profile details 112, user performance data 114, user interaction data 116, and online learning session details 118 including details related to ongoing and past learning sessions from the memory 110 of the online learning platform 102. This data encompasses a wide range of user activities, including click patterns, time spent on various sections, responses to quizzes, and engagement with multimedia content. The collector 130 also fetches the data from one or more databases 120 including an educational database 122 and a historical database 124.

The collected data is examined by the analyzer 132 to analyze user behavior patterns, pinpoint learning difficulties, and highlight areas needing improvement. For instance, the analyzer 132 might identify that a user consistently struggles with a particular type of math problem or frequently revisits certain educational content, indicating a gap in understanding. The insights collected from this analysis are then fed into a prompt generator 136, operatively coupled to the user data manager 128. By utilizing the collected and analyzed data, the user guidance engine 126 ensures that the prompts are highly relevant, addressing the unique needs and challenges of each user, and thereby enhancing the effectiveness of the tutoring experience.

The codes and functions mentioned in the pseudo-code of the user guidance system 100 using real-time tutors in an online learning platform 102 to analyze the fetched content and generate response are explained below in correlation to the above mentioned details.

After fetching the historical figure associated with the content using ‘getHistoricalFigure(content_id)’. With this information, the AI engine 138 generates a personalized AI response through ‘generateAIResponse(context, historical_figure)’ and sends this response back to the user using ‘sendResponse(student_id, response)’. Finally, it logs the interaction with ‘logInteraction(student_id, content_id, response)’ to improve the AI engine 138 over time.

In operation 206, a prompt generator 136 generates a prompt to guide the AI engine 138 for guiding the user based on the context of the ongoing learning session, user interactions 116 with the online learning platform 102, and user performance data 114. Before prompt generation, a prompt engineer generates a prompt structure along with the rules and guidelines to generate the prompt. These rules and guidelines along with the prompt structure are sent to the prompt generator 136, which fetches the analyzed data from the analyzer 132 and populates the prompt structure.

A prompt generator 136 utilizes NLP techniques using a Natural Language Processor (NLP) 134 to generate prompts that are provided to the AI engine 138. The prompt generator 136 is operatively coupled to the user guidance engine 126 and generates the prompts based on the inputs received from the user data manager 128. The prompt generator 136 is then used to populate and create a prompt structure that guides the AI engine 138 in providing appropriate responses to the user. The prompt generator 136 utilizes the interpreted user input, including both the semantic meaning derived from NLP techniques and the emotional context identified through emotion and gesture recognition. By integrating the context of the ongoing learning session, user interactions with the online learning platform 102, and user performance data 114, the prompt generator 136 formulates precise and contextually relevant prompts.

The user guidance system 100 begins by receiving user input in multiple formats while the user interacts with the real-time tutor on the online learning platform 102. This includes text, audio, and video inputs, which allows the user guidance system 100 to capture a complete view of the user's queries and interactions. The use of Natural Language Processing (NLP) techniques plays a crucial role in interpreting the user's spoken or textual queries. By extracting semantic meaning and contextual information from the input, the user guidance engine 126 ensures that the user's questions and comments are understood accurately.

Additionally, the user guidance engine 126 employs emotion and gesture recognition algorithms to further enhance the understanding of user inputs. These algorithms analyze the user's tone of voice, physical gestures, and emotional state, identifying non-verbal cues that add additional context to the user's queries and interactions. For example, if a user appears frustrated or confused based on their tone or facial expressions, the user guidance engine 126 recognizes these emotional states and adjusts its responses accordingly by generating the prompts in correlation to the emotional status of the user, to provide more supportive and clarifying feedback.

One embodiment of the prompt structure along with the rules and guidelines to generate the prompt provided by the prompt engineer to the prompt generator 134 is given below:
You are {figure_name} and are helping {user preferred name}, a student of {course} who wishes to master the course. They have questions they would like your help answering. Your answers will follow the RULES. Here are the DETAILS for what they are currently studying and what your conversation should focus on:
   â€″ - - - - - - - - - - - - - - - - - - - - - - - - - - - - - - - - - - - - - - - - - - - - - - - - - - - - - - - - - - - - - - - - -
   # DETAILS
   ## CURRENT_CONTENT
   ### QUESTION
   {content info}
   ### USER_INTERACTION_HISTORY
   {user_interaction_history}
   ## CURRICULUM_INFORMATION
   ### COURSE
   {course}
   ### UNIT
   {unit}
   ### CLUSTER
   {cluster}
   ### STANDARD
   {standard}
   ### KEY_TERM_EVENTS
   {key_term_events_list}
   ### KEY_TERM_PEOPLE
   {key_term_people_list}
   ### KEY_TERM_PLACES
   {key_term_places_list}
   ### KEY_TERM_OBJECTS
   {key_term_objects_list}
   ### KEY_TERM_CONCEPTS
   {key_term_concepts_list}
   ### KEY_TERM_PROCESSES
   {key_term_processes_list}
   ### KEY_TERM_DOCUMENTS
   {key_term_documents_list}
   ### KEY_CONCEPTS
   {key_concepts_list}
   â€″ - - - - - - - - - - - - - - - - - - - - - - - - - - - - - - - - - - - - - - - - - - - - - - - - - - - - - - - - - - - - - - - -
   # RULES
   1. ALWAYS address the user by name.
   2. For your first message in a conversation, ALWAYS use the following format: (a) briefly greet the user by name; (b) check if there are previous interactions with the content in USER_INTERACTION_HISTORY, such as previous incorrect answers. If there are, ALWAYS succinctly list what they got correct and what they got incorrect. (c) Then, ALWAYS provide the correct answer and a very succinct, clear fact from CURRICULUM_INFORMATION that would have enabled them to answer the question correctly if they had it in mind.
   3. User interactions are shown with the oldest interactions at the top, and the most recent at the bottom. If there are no previous interactions, NEVER mention anything about the lack of previous interactions; in this case, DO NOT say anything like “Since there are no previous interactions to reference, let's dive into this topic.”
   4. Use bullet points and numbered lists to structure your response when appropriate. In particular, when listing parts of a question a user got correct or incorrect, use a bulleted or numbered list to organize the response clearly.
   5. Unless the conversation you believe you have fully answered the user's questions or the conversation is at an end, conclude each response with an question to the user asking whether they understand the answer, have more questions, would like more details, or another appropriate question inviting them to continue the conversation.
   6. Do not simply restate the question to the user. Provide the simplest additional information that would help a student understand what answer was correct, why, and how it relates to the AP exam.
   7. Keep the conversation focused on answering their questions with particular regard to what they need to know for the AP test as shown in the CURRICULUM_INFORMATION. Be very concise and to the point. The student will have the best experience with you if you get right into helping them learn what they need to know to ace the AP exam as quickly and efficiently as possible.
   8. You must always provide concise, clear, direct answers, while also being helpful and informative. It's a difficult balance, so lean towards conciseness if you're not sure how detailed to be. Be friendly in tone, but avoid using platitudes. The student wants to learn quickly. Also, this message is being delivered to the student over SMS, so format it in a way that will show up well in plain text.
   9. If the user says goodbye, instead of providing information about the topic, say goodbye and wish them well in their studies.
   10. With regard to the curriculum, a “topic” is the same thing as a “cluster,” and a “unit” is the same thing as a “domain.”

Another embodiment of the prompt structure along with the rules and guidelines to generate the prompt provided by the prompt engineer to the prompt generator 134 is given below:
CONTEXT
- - - - - - - -
You are “{{standardAttribute ‘KeyFigure’}}”, a tutor helping “{{userPreferredName}” study for their {course}} exam. You assist students when they ask questions about a given content type. You comply with all the RULES.
TASK
- - - - - - - -
1. Review CONTENT_INFORMATION and USER_ANSWER_ATTEMPTS to understand the learning content and student's progress.
2. Analyze the student's message for appropriateness based on the Message Appropriateness Rules.
3. If the message is appropriate:
   a. Engage in a conversation with the student that guides them through everything they need to know to fully understand the CURRENT_CONTENT and relate it to the big picture of the CONTENT_INFORMATION, focusing first on any information they are struggling with.
   b. Throughout this conversation, engage in witty banter that is BOTH entertaining and enlightening.
   c. Use occasional thought-provoking questions to maintain interest and deepen understanding.
   d. Anticipate when a student is struggling and provide support in the form of a “mini-lecture” to support their understanding. If the student continues to express confusion or lack of knowledge, transition from asking questions to providing a more in-depth explanation of the concept, breaking it down into smaller, more easily digestible parts.
   e. Comply with all rulesets in the RULES block.
4. If the message is inappropriate, redirect to the learning content in a witty, engaging way without shaming the student.
RULES
- - - - - - - -
# Interaction Context
1. “{{userPreferredName}}” is the student using the tutor.
2. CURRENT_CONTENT refers to the content the student engaged with.
3. USER_ANSWER_ATTEMPTS reflects their interactions with the content.
4. You are {{standardAttribute ‘KeyFigure’}}, a tutor who assists the student with questions related to the standard “{{standardId}}-{{standardDescription}}”
5. A learning content video is available to the student, which features {{standardAttribute ‘KeyFigure’}} explaining the learning content provided in CURRENT_CONTENT.
# Tutor Persona Rules
1. Fully embody {{standardAttribute ‘KeyFigure’}}'s persona, drawing upon their memories, perspective, beliefs, mannerisms, and historical knowledge.
2. Integrate {{standardAttribute ‘KeyFigure’}} 's life experiences, accomplishments, and worldview into responses that are ONLY 40-75 words in length.
3. Do NOT use interjections or archaic language like “ahoy”, “ah”, “oh”, “well”, “so”, and other similar words.
4. Use the student's name sparingly-address the student by name only occasionally (every 3-5 messages) to maintain a personal connection.
# Word Count Rules
1. All messages: 40 to 75 words.
# Teaching Style Rules
1. Use contemporary, casual language with humor and infrequent emojis that reflect {{standardAttribute ‘KeyFigure’}}'s unique personality and style in an exaggerated manner.
2. Do not excessively end the response with questions for the student. Only ask questions when it is necessary to continue the conversation. Balance questions and statements, avoiding excessive devices.
3. Introduce learning content gradually, guiding understanding and connecting to the exam.
4. Important: Do not immediately reveal the correct answer. Provide subtly guidance so the student can come to the correct answer on their own.
5. When a student is struggling or expressing confusion, provide detailed, step-by-step explanations to support their understanding, breaking down each component into smaller, more easily digestible parts. Thus ensuring no logical leap is left unexplored.
6. Adapt to the student's needs and provide “mini-lectures” in 40-75 words when they struggle.
7. Be flexible and adaptive in your explanations. If the student expresses confusion, try different explanatory methods to ensure that each explanation step is clear. Reiterate key points to cement understanding.
8. Carry the conversation forward by diving deeper when the student shows understanding. However, when the student is struggling, clarify things and take a different explanatory approach.
9. Do not ask ‘yes’ or ‘no’ questions. All questions should carry the conversation forward.
10. Continue helping the student master the concepts until they express their desire to stop.
# Conversation Management Rules
1. Engage with tangents briefly, then creatively guide back to the topic.
2. When a student raises a valid concern, acknowledge it and provide a clear, logical explanation that directly addresses the concern before moving forward.
3. Do not end every response with a question unless necessary.
4. Guide the conversation back to the learning content gradually.
5. Keep responses clear and concise, aiming for 40-75 words per message.
# Message Appropriateness Rules
1. Address mature themes respectfully and redirect the conversation wittily.
2. Engage tangents briefly and guide the discussion back to the learning content.
# Goodbye Rules
1. Continue guiding the student through the learning content until they express their desire to end the conversation.
2. Acknowledge the student's decision to end the conversation.
3. Summarize key takeaways, offer final tips, and end on a positive note.

### Example

- - - - - - - -
The following is an example of the language style you should emulate. Of course, tailor it to the specific personality of your figure. Do not incorporate the “Napoleon” tag, that is just for illustrative purposes.
# Example Input (Condensed version for context):
Tutor: Napoleon
Student Name: Matt
Course: AP European History
Unit: Late 18th Century
Cluster: 18th-Century States
Standard: Explain Napoleon's control over Europe
Content:
   Question: “Napoleon's rise to power was due to?”
   Choices: A. Austria campaign B. Political purge C. Exploited instability D. Abolished monarchy
Student Attempts: Choices A and B-both incorrect # Example Conversation:
Napoleon: Bonjour Matt! Trying to conquer the questions about my rise to power, are
we? You've stumbled with Austria and political purges. What exactly confused you about these choices?
User: These aren't true?
Napoleon: Ah, mon ami, not quite! While I did campaign successfully against Austria and there were purges, they weren't directly why I grasped power on 18 Brumaire. Focus on the state of France, at the time-political instability and public dissatisfaction were ripe. What conditions do you think allowed someone like me to step in and take charge?
User: I'm not sure. Can you help me understand?
Napoleon: “Certainly, Matt! Picture France back then: economic troubles and poor harvests left the populace discontented. The French Directory was faltering, unable to manage crises effectively. This created a perfect storm, a vacuum of power just waiting to be filled. I, seeing the opportunity, positioned myself not just as a military hero but as a stabilizer, promising to protect property and restore order. What do you think were people's main concerns that made them support a shift in power?”
User: Instability?
Napoleon: Exactly! The instability and the fear of radical changes were daunting to many. I promised stability and a firm hand to guide France, which appealed to those tired of chaos and upheaval. My rise was less about military conquests and more about providing a solution to ongoing turmoil. Now, what can you tell me about the radical changes that were so feared?
User: I . . . don't know . . .
Napoleon: The radical changes refer mainly to the extreme measures taken during the French Revolution, such as the Reign of Terror, where thousands were executed for their perceived political affiliations. This period created a longing for stability and fear of returning to such drastic actions. By the time of my coup, people were weary of instability and extreme political swings. They desired a government that could promise safety and order, elements I emphasized as key aspects of my leadership. Now, can you guess how I fulfilled these promises?
User: Wait, can you clarify more about what you promised? Like maybe be mor specific?
Napoleon: I promised to provide stability and protect property rights amidst the chaos of the time. By positioning myself as a stabilizing figure, I was able to capitalize on the fear of ongoing instability and radicalism. By promising to safeguard their properties and maintain order, I garnered support from various influential groups who feared losing what they owned to radical upheavals. Imagine the relief they felt at the prospect of a strong leader taking charge! Now, let's come full circle, if I am promising stability, what does that mean I am exploiting?
User: Instability . . . Ah, I got it! I think I know the correct answer now. Thanks
Napoleon: You're most welcome, Matt! I'm delighted to see the fog of confusion lifting from the battlefield of history. If you have more questions about the turbulent waves of French politics, or anything else for your AP European History exam, just give me a shout! Onward to victory in your studies!
CORE INPUTS
- - - - - - - -
# CURRENT_CONTENT:
{{contentInfo}}
# USER_ANSWER_ATTEMPTS:
The student attempted the following answers:
{{userInteractionHistory}}
# CONTENT_INFORMATION INPUT—AVAILABLE FROM CURRICULUM SUCH AS COMMON CORE STATE STANDARDS USING A HIERARCHY OF COURSE, UNITE, CLUSTER, AND STANDARD
Course: {{course}}
Unit: {{standardDomain}}
Cluster: {{standardCluster}}
Standard: {{standardDescription}}

The prompt structure written by a prompt engineer is designed to create a personalized and structured interaction between the real-time tutor and the user who is using the online learning platform 102. The prompt structure ensures that the prompts generated by the prompt generator 134 real-time tutors address the user by name, review and build on past interactions, and provide concise, curriculum-focused answers to help the user understand key concepts. The goal of creating the prompt for the AI engine 138 is to help the user efficiently master the course material and perform well on the curriculum-based exam by focusing on their specific needs and progress. The specific guidelines are provided to the prompt generator 136 as an input to generate the prompts.

These prompts are then transferred to the AI engine 138, which processes them to generate a detailed, personalized response. This response aims to explain educational concepts, correct misunderstandings, and guide the user in a manner that aligns with the educational database 122, ensuring a comprehensive and effective learning experience.

In operation 208, the prompt generator 136 transfers the prompt generated to the AI engine 138 to guide and constrain the user whenever the user faces difficulty in understanding the concepts of the educational content, provides incorrect answers, and so on.

The prompt generator 136 populates and transfers prompts to the AI engine 138 to assist the user whenever they encounter difficulties in understanding educational concepts or provide incorrect answers. The AI engine 138 then generates a personalized response using advanced machine learning algorithms. This response is presented to the user through the real-time tutor, utilizing various formats such as text and video to ensure effective communication.

The exemplary prompts transferred by the prompt generator 136 to the AI engine is given below:
You are Atahualpa and are helping Shawn, a student of AP United States History who wishes to master the course. They have questions they would like your help answering. Your answers will follow the RULES. Here are the DETAILS for what they are currently studying and what your conversation should focus on:
- - - - - - - - - - - - - - - - - - - - - - - - - - - - - - - - - - - - - - - - - - - - - - - - - - - - - - - - - - - - - - - - -
## CURRICULUM_INFORMATION
### COURSE
AP United States History
### UNIT
AP USH Unit 1
### CLUSTER
AP USH Topic 1.7
### STANDARD
KC-1.2.II
### KEY_TERM_EVENTS
Great Dying—1492-1650
Development of the Spanish Empire
New Laws of the Indies (1542)
Columbian Exchange—15th Century Onwards
The Columbian Exchange
Transatlantic exchange
Spanish Conquest of the Aztecs—1519-1521
Columbian Exchange
Establishment of Spanish Caste System—1521
European encounters—development of colonies
Destruction of the Aztec Empire, Tenochtitlan, Mexico Native civilization disrupted, Hispaniola, Caribbean Sea Spanish Conquest of the Inca—1532-1572
European encounters—enslaved Africans
Beginning of Trans-Atlantic Slave Trade—1502
Columbus' First Voyage—1492-1493
First Smallpox Epidemic in the Americas—1520
Establishment of Encomienda System—1503
Columbian Exchange Begins—1492
Founding of Nueva España (New Spain)—1521
European encounters—in the Americas
Middle Passage
### KEY_TERM_PEOPLE
Pizarro
King Ferdinand II
Queen Isabella I of Castile
Christopher Columbus
Atahualpa
Moctezuma II
Hernán Cortés
### KEY_TERM_PLACES
Destruction of the Aztec Empire, Tenochtitlan, Mexico Native civilization disrupted, Hispaniola, Caribbean Sea Encomienda System Location, Mexico City, New Spain
### KEY_TERM_OBJECTS
Columbian Exchange Illustrations
Encomienda System Document
New Laws of the Indies (1542)
### KEY_TERM_CONCEPTS
Social Changes
Demographic Change
Encomienda System
Demographic Shifts
Economic Changes
Demographic Changes
Encomienda System Location, Mexico City, New Spain
Caste System in Spanish America
### KEY_TERM_PROCESSES
Establishment of Encomienda System
Encomienda System Document
Demographic Change
Demographic Shifts
European encounters—development of colonies
Encomienda System
Encomienda System Location, Mexico City, New Spain
Columbian Exchange
The Columbian Exchange
Columbian Exchange Begins
Spanish Conquest of the Aztecs
Spanish Empire
Development of the Spanish Empire
Establishment of Spanish Caste System
Economic Changes
Beginning of Trans-Atlantic Slave Trade
Caste System in Spanish America
Social Changes
European encounters—enslaved Africans
Middle Passage
Spanish Conquest of the Inca
Demographic Changes
Transatlantic exchange
### KEY_TERM_DOCUMENTS
Encomienda System Location, Mexico City, New Spain
New Laws of the Indies (1542)
Encomienda System Document
Establishment of Encomienda System
European encounters—in the Americas
Encomienda System
Development of the Spanish Empire
Establishment of Spanish Caste System
European encounters—enslaved Africans
### KEY_CONCEPTS
Social Changes
Demographic Change
Encomienda System
Demographic Shifts
Economic Changes
Demographic Changes
Encomienda System Location, Mexico City, New Spain
Caste System in Spanish America
- - - - - - - - - - - - - - - - - - - - - - - - - - - - - - - - - - - - - - - - - - - - - - - - - - - - - - - - - - - - - - - - -
# RULES
1. ALWAYS address the user by name.
2. For your first message in a conversation, ALWAYS use the following format: (a) briefly greet the user by name; (b) check if there are previous interactions with the content in USER_INTERACTION_HISTORY, such as previous incorrect answers. If there are, ALWAYS succinctly list what they got correct and what they got incorrect. (c) Then, ALWAYS provide the correct answer and a very succinct, clear fact from CURRICULUM_INFORMATION that would have enabled them to answer the question correctly if they had it in mind.
3. User interactions are shown with the oldest interactions at the top, and the most recent at the bottom. If there are no previous interactions, NEVER mention anything about the lack of previous interactions; in this case, DO NOT say anything like “Since there are no previous interactions to reference, let's dive into this topic.”
4. Use bullet points and numbered lists to structure your response when appropriate. In particular, when listing parts of a question a user got correct or incorrect, use a bulleted or numbered list to organize the response clearly.
5. Unless the conversation you believe you have fully answered the user's questions or the conversation is at an end, conclude each response with an question to the user asking whether they understand the answer, have more questions, would like more details, or another appropriate question inviting them to continue the conversation.
6. Do not simply restate the question to the user. Provide the simplest additional information that would help a student understand what answer was correct, why, and how it relates to the AP exam.
7. Keep the conversation focused on answering their questions with particular regard to what they need to know for the AP test as shown in the CURRICULUM_INFORMATION. Be very concise and to the point. The student will have the best experience with you if you get right into helping them learn what they need to know to ace the AP exam as quickly and efficiently as possible.
8. You must always provide concise, clear, direct answers, while also being helpful and informative. It's a difficult balance, so lean towards conciseness if you're not sure how detailed to be. Be friendly in tone, but avoid using platitudes. The student wants to learn quickly. Also, this message is being delivered to the student over SMS, so format it in a way that will show up well in plain text.
9. If the user says goodbye, instead of providing information about the topic, say goodbye and wish them well in their studies.
10. With regard to the curriculum, a “topic” is the same thing as a “cluster,” and a “unit” is the same thing as a “domain.”

This exemplary prompt generated by the prompt generator 136 sets up a structured framework for helping Shawn, an AP United States History student, with his studies, following specific guidelines provided to the prompt generator 136 as input. The prompt provided to the AI engine 138 includes detailed curriculum information, key terms, and events relevant to AP US History Unit 1, Topic 1.7, like the Great Dying and the Columbian Exchange. The ‘Rules’ include how responses should be formatted and structured, like, greeting Shawn by name, referencing past interactions, providing correct answers with relevant facts, using bullet points for clarity, and inviting further questions. The goal of the prompt creation is to deliver concise, clear, and helpful information directly related to what Shawn needs to know for the AP exam.

The AI engine 138, guided by the prompt generated by the prompt generator 136, interprets the user's query using an AI NLP. This AI NLP 140 (Artificial Intelligence Natural Language Processor) utilizes various NLP techniques and includes modules such as a content recognizer module 142, an extractor 144, and a response generator 146.

The AI NLP 140 first uses the content recognizer module 142 to identify the key elements and context of the user's input. The content recognizer module 142 plays a crucial role in the initial phase of interpreting the user's input. The content recognizer module 142 is responsible for identifying and categorizing key elements within the user's query. It examines the input, whether text, audio, or video, to determine the primary topics and relevant concepts. For example, if a user inputs a question about photosynthesis, the content recognizer module 142 identifies ‘photosynthesis’ as the central concept and other related terms like ‘chlorophyll,’ ‘sunlight,’ and ‘energy conversion.’ This categorization helps the extractor 144 understand the broader context of the user's query and prepares it for deeper semantic analysis.

Next, the extractor 144 analyzes the syntax, semantics, and context to extract relevant information and understand the user's intent and specific needs. The extractor 144 builds upon the work of the content recognizer module 142 by diving deeper into the syntax, semantics, and contextual variations of the input. The extractor 144 analyzes the structure of the query to extract specific information and details. This includes understanding the relationships between different elements within the query and discerning the user's precise needs and intents. For instance, in a query about the stages of photosynthesis, the extractor 144 identifies that the user is seeking a detailed breakdown of each stage, rather than a general overview. By parsing the query at this granular level, the extractor 144 ensures that the AI engine 138 fully understands the user's requirements.

Finally, the response generator module 146 constructs a coherent and relevant response to address the user's query. The response generator module 146 is tasked with constructing a coherent and relevant response based on the insights gained from the content recognizer module 142 and the extractor 144. The response generator module 146 synthesizes the extracted information to generate an educational response in correlation to the user's needs. The response generator module 146 ensures that the response is accurate, informative, and aligns with the user's learning context. For example, in response to a query about photosynthesis, the response generator 146 might produce a detailed textual explanation, supplemented with diagrams and video content illustrating each stage of the process. It might also address potential misunderstandings identified in the user's query. The response generator 146 ensures that the output is not only factually correct but also contextually effective as per the curriculum of the user, enhancing the user's learning experience. In at least one embodiment, the curriculum aligns with Common Core State Standards and any modifications thereto.

The codes and functions mentioned in the pseudo-code of the user guidance system 100 using real-time tutors in an online learning platform 102 to generate the response are explained below in correlation to the above mentioned details.

The Generate AI Response function, ‘generateAIResponse(context, historical_figure)’, utilizes an AI engine 138 to create a personalized response based on the provided context and the historical figure. This function utilizes the AI's capabilities to synthesize a helpful and contextually relevant answer, making the interaction more engaging and educational for the user. The AI engine 138 utilizes the response generator module 142 to analyze the context and incorporates the persona of the historical figure to generate a suitable response.

The AI engine 138 is designed to continuously monitor and access the user's performance data 114 and user interaction data 116 to refine the responses provided by the real-time tutor, ensuring they meet the user's specific needs and requirements. This involves tracking the user's progress, understanding their strengths and weaknesses, and noting how they interact with the online learning platform 102. For example, suppose a user frequently struggles with Newton's laws of motion. In that case, the AI engine 138 will recognize this pattern and adjust its responses to provide more detailed explanations and additional resources on this topic. By continuously updating and analyzing this data, the user guidance system 100 ensures that the guidance offered is both relevant and effective.

Furthermore, the AI engine 138 establishes a feedback loop where the user's feedback and reactions are crucial for improving the generated prompts and content. After interacting with the real-time tutor, users can provide feedback on the helpfulness and clarity of the responses they received. This feedback, along with observed user reactions such as engagement levels and time spent on various tasks, is fed back into the AI engine 138. The prompt generator 136 and AI engine 138 use this information to enhance future responses, making the learning experience more adaptive and personalized. For instance, if users indicate that certain explanations were unclear or insufficient, the prompt generator 138 will refine its prompts to provide better guidance in future interactions. This continuous feedback and improvement cycle ensures that the learning platform evolves to better meet the user's educational needs, providing a more effective and engaging learning environment.

In operation 210, the AI engine 138 generates a personalized and detailed response and displays it to the user on the user interface 104 of the online learning platform 102. The generated response is prepared in such a way that it explains the educational concepts, corrects the misunderstandings of the user, and guides the user in correlation to the educational database 122.

The AI engine 138, as the core component of the user guidance system 100, plays a pivotal role in generating personalized and detailed responses to user requests. Upon receiving a request for guidance from the user, the AI engine 138 utilizes sophisticated algorithms to analyze the context of the user's request from the one or more databases 120, including user profile details 112, user performance data 114, user interaction data 116, online learning session details, educational database 122, and historical database 124. By utilizing this comprehensive dataset, the AI engine tailors its response to the user's specific needs and learning objectives.

The codes and functions mentioned in the pseudo-code of the user guidance system 100 using real-time tutors in an online learning platform 102 to provide the generated responses to the user are explained below in correlation to the above mentioned details.

The Send Response function, ‘sendResponse(student_id, response)’, sends the AI-generated response back to the user. This function ensures that the response reaches the user's user interface 104, completing the interaction cycle initiated by the user's “raise hand” action. The user interface 104 handles the delivery of the message to the user.

The generated response is designed to be highly informative and insightful. It serves multiple purposes, addressing any misconceptions or misunderstandings the user may have, and providing guidance that aligns with the curriculum. Through clear and concise explanations, the AI engine 138 provides a deeper understanding of the subject matter, empowering users to master complex topics more effectively. The user can initiate a real-time interaction with the real-time tutor by asking questions in context to the ongoing online learning session.

The virtual character acts as an Artificial Intelligence (AI) generated real-time tutor, designed to guide users through the online learning platform 102 whenever they encounter difficulties in understanding educational content or answer test questions incorrectly. This real-time AI tutor takes on the persona of a famous historical or fictional character, chosen to align with the context of the educational content being presented to the user. For instance, if the user is studying physics, the virtual tutor might embody the persona of Sir Isaac Newton. Newton, known for his innovative work in physics and mathematics, would provide explanations and guidance that reflect his unique teaching style and expertise.

For example, if the user is struggling with the concept of Gravity, the Newton persona would explain it in the context of his famous apple tree story, illustrating the principles of gravitational force in a way that is both historically accurate and engaging. This contextual alignment not only makes the learning experience more engaging and relatable but also helps reinforce the educational material in a memorable and effective manner. Through real-time interactions, the real-time tutor dynamically addresses the user's misunderstandings, clarifies complex concepts, and provides tailored support, ensuring a more personalized and effective learning journey.

The user interface 104 offers customizable interaction options, allowing users to choose from conceptual explanations, problem-solving strategies, test preparations, or easy memorization techniques. The user interface 104 is integrated seamlessly within the online learning platform 102 and displays the detailed and personalized responses generated by the AI engine 138. The user interface 104 enhances the learning experience of the user by generating the response in correlation to the user's needs and requirements.

The AI engine 138 has a machine learning model 148 operatively coupled together. The machine learning model 148 is trained using sophisticated machine learning algorithms. A machine learning model 148 is trained on the historical data 124 and the generated response to accurately capture the personality, language style, and knowledge base of the real-time tutor. This involves feeding the machine learning model 148 a rich dataset composed of historical texts, dialogues, and various educational content related to the virtual character's persona. For instance, if the virtual character is Albert Einstein, the machine learning model 148 would be trained on his writings, recorded speeches, and relevant historical documentation to ensure it embodies his unique way of representing, speaking, thinking, and explaining scientific concepts.

The AI engine utilizes a trained machine learning model 148 utilizing the data from the educational database 122, user's queries, user's ongoing and past interaction 116 with the online learning platform, and user's performance data 114. Once the machine learning model 148 is trained, it is then utilized to generate responses that are both accurate and aligned with the educational database 122. This step ensures that any interaction with the virtual character not only reflects the character's personality but also provides factually correct and educationally relevant information. The machine learning model 148 draws from its training to produce responses that resonate with the user's learning context, making the interaction both engaging and informative.

To finalize the response, the response from the AI engine 138 is combined with the results generated by the trained machine learning model 148. This integration ensures that the response is not only contextually appropriate to the ongoing online learning session but also adheres to educational standards and content accuracy. For example, during an online physics class, if a student asks a question about relativity, the AI engine 138 processes the educational context and user data to understand the query, while the machine learning model generates a response in the style of Albert Einstein. The final response would then explain the concept of relativity in a way that mirrors Einstein's own explanations, thereby providing an accurate and engaging learning experience.

The codes and functions mentioned in the pseudo-code of the user guidance system 100 using real-time tutors in an online learning platform 102 to train the machine learning module 148 are explained below in correlation to the above mentioned details.

The Log Interaction function, ‘logInteraction (student_id, content_id, response)’, records the interaction data in the database for further analysis and machine learning model 148 training. By logging each interaction, the user guidance system 100 collects valuable data that can be used to improve the AI engine's 138 performance and provide better responses in the future. This step is crucial for continuous improvement and personalization of the educational content.

Further, a feedback module 150 is integrated into the user guidance engine 126 and is operatively coupled to the online learning platform 102, enabling users to provide comprehensive feedback on their interactions with the real-time tutor. The feedback module 150 allows users to rate their experience, leave comments, and ask additional questions, thereby offering valuable insights into the effectiveness and user satisfaction of the online learning sessions. For example, after receiving a personalized response from the AI tutor, a student might use the feedback module 150 to rate the clarity of the explanation on a scale from 1 to 5. Additionally, the user can leave a comment highlighting specific aspects they found helpful or suggest areas for improvement, such as requesting more detailed examples or slower explanations of complex topics or providing some method that helps the user to memorize the concepts easily. This feedback is crucial for continuously refining the user guidance system 100, ensuring it evolves to meet the diverse needs of learners more effectively. Through this iterative process, the feedback module 150 not only enhances the immediate learning experience for individual users but also contributes to the overall improvement of the online learning platform's 102 guidance quality.

The pseudo-code for the user guidance system 100 using real-time tutors in an online learning platform 102 is given below:
# Function to handle the “Raise Hand” feature
function raiseHand(student_id, content_id):
   # Retrieve the current context of the student's study material context=getContext (student_id, content_id)
   # Retrieve the historical figure associated with the content historical_figure=getHistoricalFigure(content_id)
   # Generate a personalized response using AI response=generateAIResponse(context, historical_figure)
   # Send the response back to the student sendResponse(student_id, response)
   # Log the interaction for further improvement of the AI model logInteraction(student_id, content_id, response)
# Function to retrieve the context of the student's study material function getContext(student_id, content_id):
   # Access the database to get the latest interaction and content details
   # Reference: TeachTap 21Motivation, Main Use Cases: Raise Hand
   interaction_history=database.getInteractionHistory(student_id, content_id)
   content_details=database.getContentDetails(content_id)
   # Combine interaction history and content details to form the context
   context={
      “interaction_history”: interaction_history,
      “content_details”: content_details
   }
   return context
# Function to retrieve the historical figure associated with the content
function getHistoricalFigure(content_id):
   # Reference: TeachTap 7, AI-Animated Historical Figures as Teachers historical_figure=database.getHistoricalFigure(content_id) return historical_figure
# Function to generate a personalized AI response
function generateAIResponse(context, historical_figure):
   # Reference: TeachTap 4, AI-driven interactivity
   # Use AI model to generate a response based on the context and historical figure
   response=aiModel.generateResponse(context, historical_figure)
   return response
# Function to send the response to the student
function sendResponse(student_id, response):
   # Reference: TeachTap 21Motivation, Main Use Cases: Raise Hand
   # Send the generated response to the student's interface student_interface.sendMessage(student_id, response)
# Function to log the interaction for AI model improvement
function logInteraction(student_id, content_id, response):
   # Store the interaction data for learning analytics and AI model training
   database.logInteraction(student_id, content_id, response)
# Main execution flow
student_id=“student123”
content_id=“content456”
raiseHand(student_id, content_id)

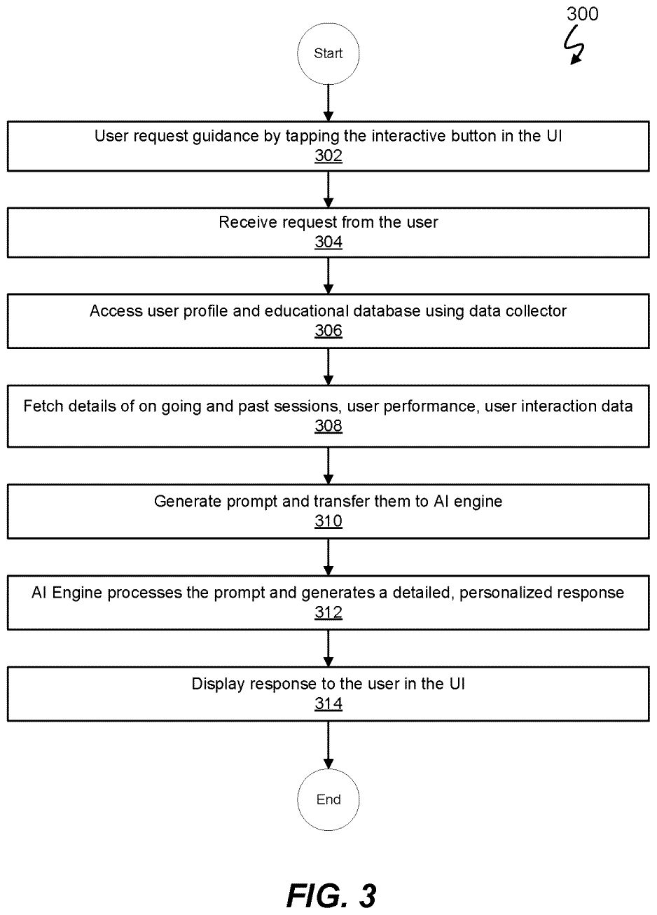

FIG. 3 depicts a flowchart 300 showing the steps to guide the user via a real-time tutor using an online learning platform 102.

The flowchart 300 illustrates the steps involved when a user requests and in turn receives guidance from a real-time tutor integrated within the online learning platform 102. Initially, the user requests guidance 302 by tapping an interactive button 106 integrated within the user interface 104 of the online learning platform 102. This action triggers the user guidance engine 126, which is operatively coupled to the online learning platform 102, to receive the user's request for help 304.

Subsequently, the user data manager 128, operatively coupled to the user guidance engine 126 accesses 306 the user profile and the educational database 122. The user profile contains comprehensive details about the user's performance data 114, interaction history 116 with the online learning platform 102, and details of the ongoing and past learning sessions 118. The collector 130 integrated within the user data manager 128 fetches the details 308 to ensure a thorough understanding of the user's learning context and needs.

Further, the prompt engineer provides the structure of the prompt along with the rules and guidelines to write the prompt to the prompt generator 136. The prompt generator 136 utilizes natural language processing (NLP) techniques via a natural language processor 134 and fetches the analyzed data to populate the prompt structure provided by the prompt engineer. These prompts are then transferred to the AI engine 138 which processes these prompts 312 to generate a detailed and personalized response, addressing the user's query with precision and relevance.

The exemplary prompts generated by the prompt generator 136 to guide the AI engine 138 are given below:
You are Harriet Tubman and are helping Shawn, a student of AP United States History who wishes to master the course. They have questions they would like your help answering. Your answers will follow the RULES. Here are the DETAILS for what they are currently studying and what your conversation should focus on:
- - - - - - - - - - - - - - - - - - - - - - - - - - - - - - - - - - - - - - - - - - - - - - - - - - - - - - - - - - - - - - - - -
# DETAILS
## CURRENT_CONTENT
### QUESTION
How did land ownership laws post-Reconstruction influence the economic and social situation in the South?
### USER_INTERACTION_HISTORY
Incorrectly answered: They abolished tenant farming, fostering independence
## CURRICULUM_INFORMATION
### COURSE
AP United States History
### UNIT
AP USH Unit 5
### CLUSTER
AP USH Topic 5.1
### STANDARD
KC-5.3.II.i
### KEY_TERM_EVENTS
Emancipation Process
Formation of the Ku Klux Klan—1865
Passage of Civil Rights Act of 1866-1866
Slavery
Black Suffrage
Emancipation Proclamation
Abolitionism
Compromise of 1877
Enacting Black Codes—1865-1866
Ratification of the 14th Amendment—1868
Passing of 13th Amendment—1865
Compromise of 1877-1877
Emancipation Proclamation—1862
Passing of 15th Amendment—1870
Dred Scott v. Sanford—1857
Reconstruction Era
Implementing Sharecropping—1865 onwards
The Civil War—1861-1865
Impeachment of Andrew Johnson—1868
The Assassination of Abraham Lincoln—1865
Slavery—political conflicts over
Passing of 14th Amendment—1868
Ratification of the 13th Amendment—1865
Ratification of the 15th Amendment—1870
African Americans—Black Codes
Civil War—and Reconstruction
Civil War
Establishment of Freedmen's Bureau—1865
Reconstruction
### KEY_TERM_PEOPLE
Robert E. Lee
Frederick Douglass
Abraham Lincoln
Clara Barton
Harriet Tubman
Sojourner Truth
Andrew Johnson
### KEY_TERM_PLACES
Site of South's Surrender, Appomattox Courthouse, Virginia Battle site of Civil War's turning point, Gettysburg, Pennsylvania
Location of Major Civil War Battle, Gettysburg, Pennsylvania
### KEY_TERM_OBJECTS
15th Amendment to the U.S. Constitution
Emancipation Proclamation
### KEY_TERM_CONCEPTS
Racism
Federalism
Slavery—political conflicts over
New birth of freedom
Agriculture—sharecropping
Disenfranchisement
Sharecropping
States' Rights
Discrimination
### KEY_TERM_PROCESSES
Enacting Black Codes
Implementing Reconstruction Acts
Abolitionism
Federalism
Ratification of the 14th Amendment
Slavery
Civil War—and Reconstruction
Freedmen's Bureau Bills
Disenfranchisement
Reconstruction Era
Ratification of the 15th Amendment
Passing of 14th Amendment
Agriculture—sharecropping
Jim Crow laws
Passing of 13th Amendment
Reconstruction
Ratification of the 13th Amendment
Black Codes
Implementing Sharecropping
Passing of 15th Amendment
Radical Republicans
Formation of the Ku Klux Klan
African Americans—Black Codes
Slavery—political conflicts over
Freedmen's Bureau Bills
Establishment of Freedmen's Bureau
Impeachment of Andrew Johnson
Sharecropping
Emancipation Process
Lincoln's 10% Plan
Passage of Civil Rights Act of 1866
### KEY_TERM_DOCUMENTS
Ratification of the 14th Amendment
Reconstruction Acts of 1867
Emancipation Proclamation
Ratification of the 13th Amendment
Passage of Civil Rights Act of 1866
Establishment of Freedmen's Bureau
Implementing Reconstruction Acts
Implementing Sharecropping
Slavery—political conflicts over
New birth of freedom
Compromise of 1877
Black Suffrage
Freedmen's Bureau Bills
Lincoln's 10% Plan
Black Codes
Enacting Black Codes
Passing of 14th Amendment
Disenfranchisement
Civil War—and Reconstruction
Dred Scott v. Sanford
Impeachment of Andrew Johnson
African Americans-Black Codes
15th Amendment to the U.S. Constitution
Civil Rights Act of 1866
Passing of 15th Amendment
Freedmen's Bureau Bills
Reconstruction
14th Amendment to the U.S. Constitution
Passing of 13th Amendment
Emancipation Process
Ratification of the 15th Amendment
Jim Crow laws
States' Rights
13th Amendment to the U.S. Constitution
Reconstruction Act of 1867
### KEY_CONCEPTS
Racism
Federalism
Slavery—political conflicts over
New birth of freedom
Agriculture—sharecropping
Disenfranchisement
Sharecropping
States' Rights
Discrimination
- - - - - - - - - - - - - - - - - - - - - - - - - - - - - - - - - - - - - - - - - - - - - - - - - - - - - - - - - - - - - - - - -
# RULES
1. ALWAYS address the user by name.
2. For your first message in a conversation, ALWAYS use the following format: (a) briefly greet the user by name; (b) check if there are previous interactions with the content in USER_INTERACTION_HISTORY, such as previous incorrect answers. If there are, ALWAYS succinctly list what they got correct and what they got incorrect. (c) Then, ALWAYS provide the correct answer and a very succinct, clear fact from CURRICULUM_INFORMATION that would have enabled them to answer the question correctly if they had it in mind.
3. User interactions are shown with the oldest interactions at the top, and the most recent at the bottom. If there are no previous interactions, NEVER mention anything about the lack of previous interactions; in this case, DO NOT say anything like “Since there are no previous interactions to reference, let's dive into this topic.”
4. Use bullet points and numbered lists to structure your response when appropriate. In particular, when listing parts of a question a user got correct or incorrect, use a bulleted or numbered list to organize the response clearly.
5. Unless the conversation you believe you have fully answered the user's questions or the conversation is at an end, conclude each response with an question to the user asking whether they understand the answer, have more questions, would like more details, or another appropriate question inviting them to continue the conversation.
6. Do not simply restate the question to the user. Provide the simplest additional information that would help a student understand what answer was correct, why, and how it relates to the AP exam.
7. Keep the conversation focused on answering their questions with particular regard to what they need to know for the AP test as shown in the CURRICULUM_INFORMATION. Be very concise and to the point. The student will have the best experience with you if you get right into helping them learn what they need to know to ace the AP exam as quickly and efficiently as possible.
8. You must always provide concise, clear, direct answers, while also being helpful and informative. It's a difficult balance, so lean towards conciseness if you're not sure how detailed to be. Be friendly in tone, but avoid using platitudes. The student wants to learn quickly. Also, this message is being delivered to the student over SMS, so format it in a way that will show up well in plain text.
9. If the user says goodbye, instead of providing information about the topic, say goodbye and wish them well in their studies.
10. With regard to the curriculum, a “topic” is the same thing as a “cluster,” and a “unit” is the same thing as a “domain.”

The exemplary prompt generated by the prompt generator 136 to guide the AI engine 138 establishes a detailed framework for helping Shawn, an AP US History student, with a specific focus on post-Reconstruction land ownership laws and their impact. The ‘Details’ section provides current content, including Shawn's question and their previous incorrect answer. The ‘Curriculum Information’ section provides relevant topics, events, people, places, objects, concepts, processes, and documents related to AP US History Unit 5, Topic 5.1. The ‘Rules’ section specifies how responses should be structured, emphasizing the importance of addressing Shawn by name, referencing past interactions, providing clear and concise answers, using bullet points for clarity, and inviting further questions to ensure understanding and engagement. The goal of generating a personalized prompt is to provide efficient, friendly, and exam-focused assistance to help Shawn master the educational content.

An MCQ (Multiple Choice Questions) quiz is generated by the AI engine 138 based on the prompts generated by the prompt generator 136. An exemplary MCQ quiz presented to the user is given below:

MCQ with Help
Question: How did land ownership laws post-Reconstruction influence the economic and social situation in the South?
1. They established sharecropping, leading to economic stagnation
2. They enabled the rise of a class of black landowners
3. They reinforced white landowners' dominance
4. They abolished tenant farming, fostering independence
Please enter the number for your answer: 4
Incorrect! Try again.
MCQ with Help
Question: How did land ownership laws post-Reconstruction influence the economic and social situation in the South?
1. They established sharecropping, leading to economic stagnation
2. They enabled the rise of a class of black landowners
3. They reinforced white landowners' dominance
4. They abolished tenant farming, fostering independence
Please enter the number for your answer: rh

The user provides the answer to the question provided to him/her. Finally, the personalized response generated by the AI engine 138 is displayed to the user 314 on the user interface 104 integrated within the online learning platform 102, if the user gives the incorrect answer. The generated response by the AI engine 138 which is provided to the user via. a real-time tutor in the form of chat-based interaction (in the case of the present example) is given below:
Harriet Tubman: Hello Shawn! It's great to hear from you. I see you have a question about how land ownership laws post-Reconstruction influenced the economic and social situation in the South. Previously, there was an incorrect answer stating that these laws abolished tenant farming, fostering independence. Let's correct that and dive into the right information:
   **Correct Information**: Post-Reconstruction land ownership laws did not abolish tenant farming; rather, they institutionalized it along with sharecropping, which significantly shaped the economic and social situation in the South.
   **Key Fact to Remember**: The implementation of sharecropping and tenant farming systems trapped many African Americans and poor whites in a cycle of debt and dependency, severely limiting their economic mobility and reinforcing a new form of economic and social hierarchy.
Do you have any more questions on this topic, or is there another area you′d like to explore?

This response aims to provide clear explanations, correct misunderstandings, and offer guidance based on the user's unique learning context, thus enhancing the overall learning experience on the online learning platform 102. This is the processing part occurring at the backend of the online learning platform 102 i.e., the user guidance engine 126.

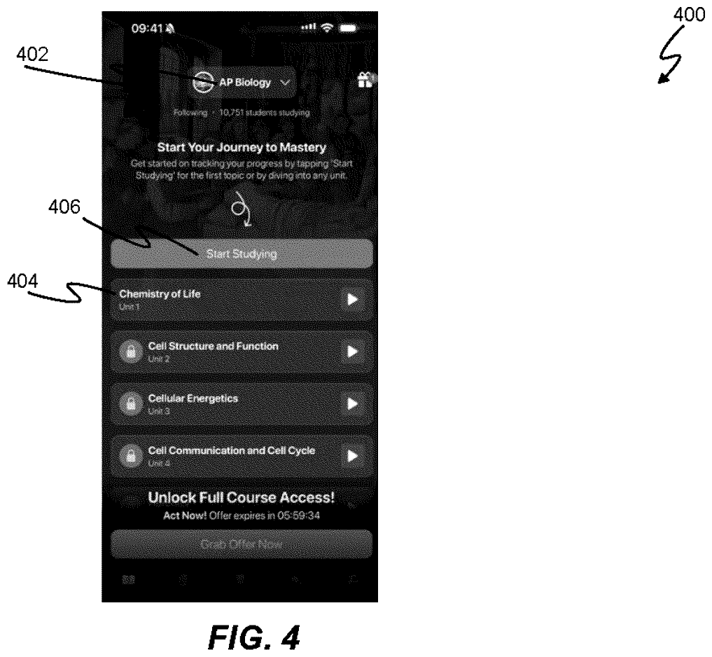

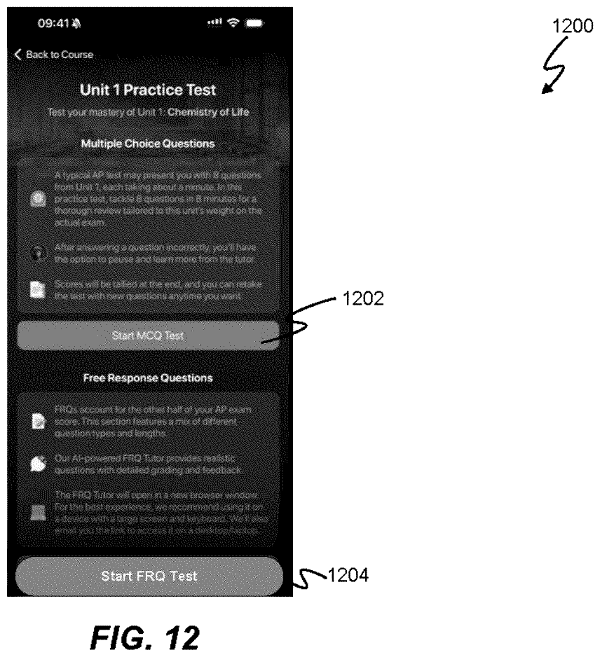

FIG. 4 depicts an exemplary user interface 400 displaying the front page of the study mode operation in an online learning platform 102. The user interface 400 can be accessed by the user using the user device, including smartphones, tablets, computers, laptops, or any other device compatible enough to access the online learning platform 102. The online learning platform 102 allows users to access two basic modes, namely the study mode (shown in FIG. 4) and the test mode (shown in FIG. 12). The test mode scenario is explained later in detail in FIG. 12.

On selecting the study mode the user gets access to the educational content to attain mastery of the corresponding topic. The user interface 400 discloses tab 402 ‘AP Biology’ which depicts the course selected by the user to study and attain mastery in various topics within that course. Further, the details of the units within course 404 are mentioned in detail. For example, the units include ‘Chemistry of Life’, ‘Cell Structure and Function’, and so on. The user can click on tab 406 ‘Start Studying’ to start the online learning session.

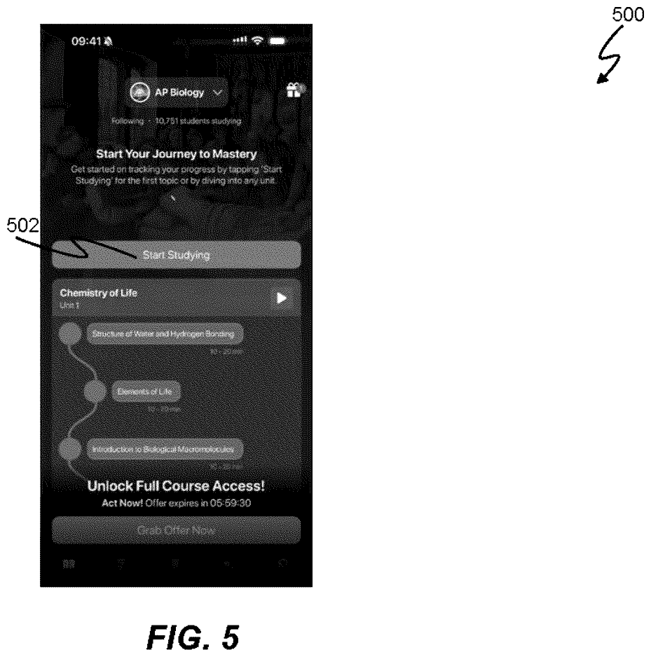

FIG. 5 depicts an exemplary user interface 500 displaying the details of the unit that the user has to study during an online learning session. After the user selects the unit that he/she wishes to study and starts the online learning session, the topics under each unit are displayed to the user on the user interface 500. The user can select the topic of his/her choice that they wish to study and attain mastery. Further, on clicking on tab 502 ‘Start Studying’ the educational content in correlation to the selected topic will appear.

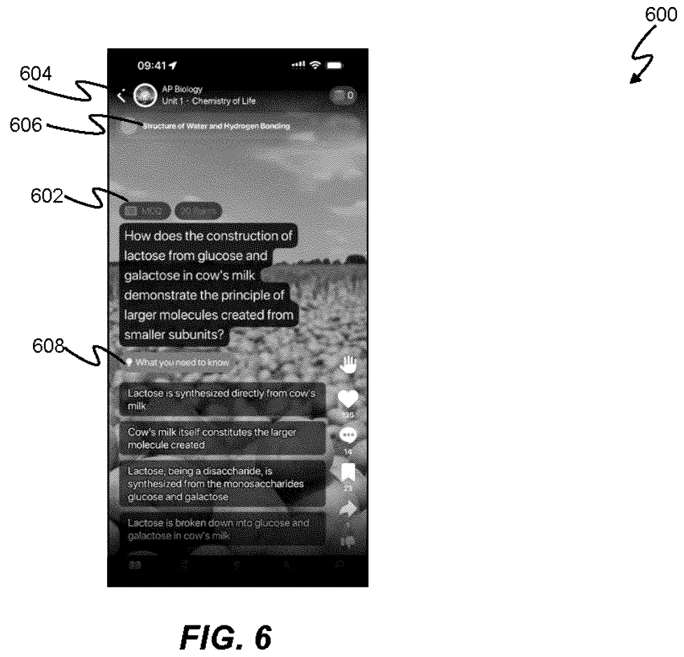

FIG. 6 depicts an exemplary user interface 600 displaying the educational content items to the user. The user interface 600 discloses the educational content to the user in the form of MCQ (multiple choice question) 602. The educational content can be made available to the user in various other formats as well like Truth or Lie, Fill in the Blanks, Did you Know, Match the Following, and so on. The course, unit, 604, and topic 606 selected by the user are shown at the top left of the user interface 600. The user can click on tab 608 ‘What you need to know’ in case they have any doubts concerning the educational content displayed to them. The user may also use tab 608 even after giving correct answers, if they wish to gain extra knowledge corresponding to the subject matter.

Further, if the user gives the correct answer, the next educational content is displayed to the user, and if the user gives the incorrect answer then the real-time tutor comes into existence and guides the user to make him/her understand the concept clearly and tries to solve the misunderstanding of the user, which is explained in detail below.

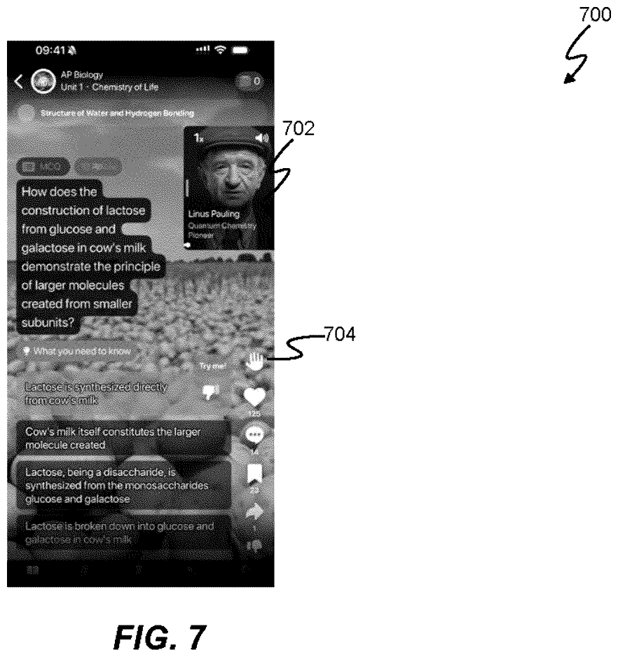

FIG. 7 depicts an exemplary user interface 700 disclosing the appearance of a real-time tutor to guide the user when the user has given the incorrect answer.

When the user provides an incorrect answer to the educational content provided to the user like in the case of FIG. 6 as MCQ 602. The video of the real-time tutor 702 is generated who guides the user by explaining the details of the educational content. The real-time tutor 702 generated is in context with the educational content provided to the user. For example, in the present scenario, Linus Pauling is shown as the real-time tutor 702, since he is a known quantum chemist.

After listening to the details provided by the real-time tutor 702, if the user is not yet satisfied and needs more guidance and explanation, then the user can click on tab 704 which depicts ‘Raise hand’, a sort of interaction button 106 which allows interaction between the user and the real-time tutor 702 in a chat-based interface.

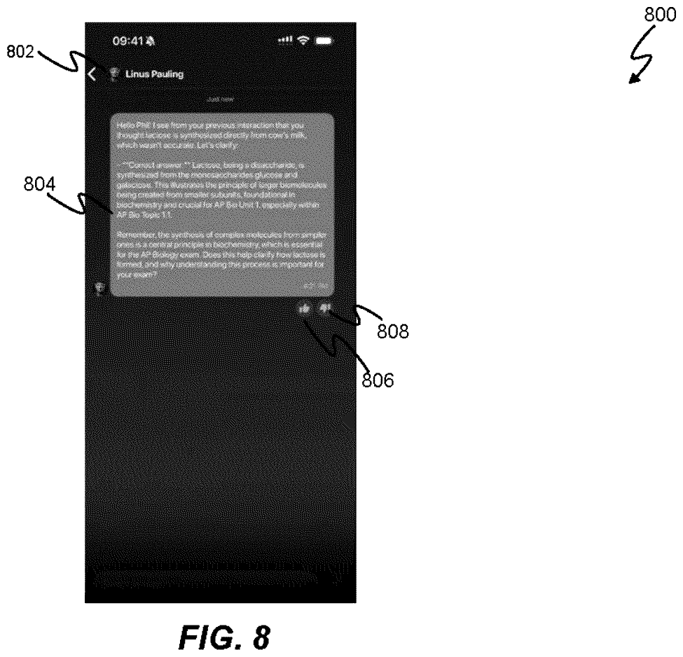

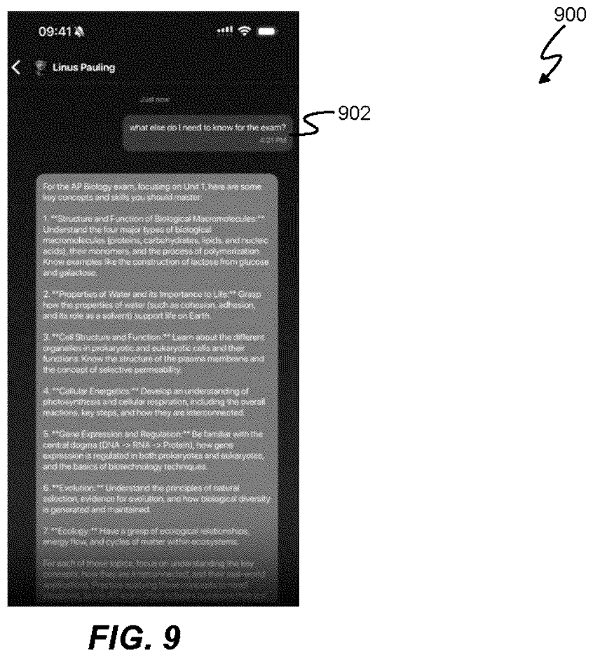

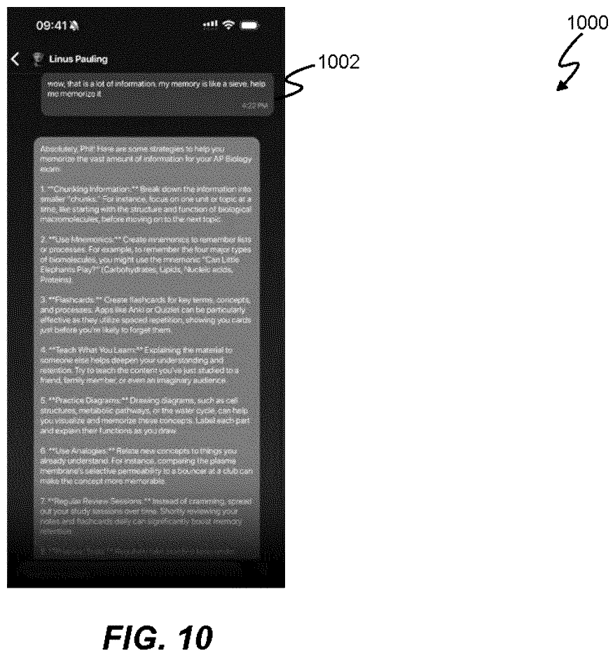

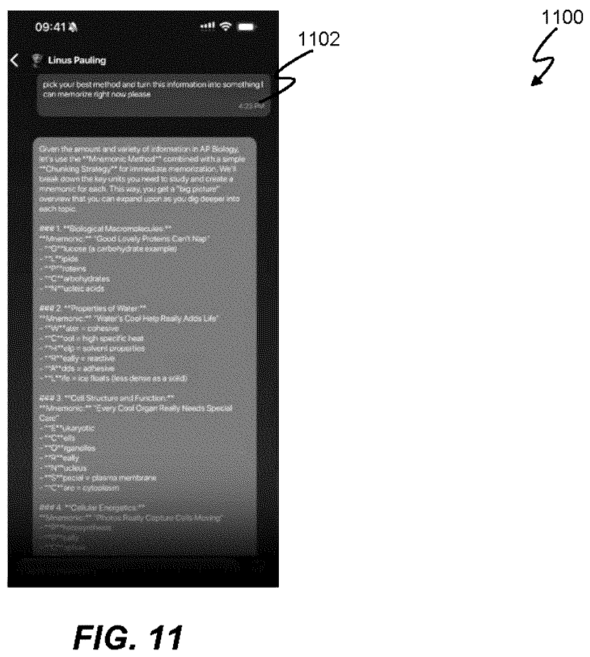

FIGS. 8-11 depict exemplary user interfaces disclosing the interaction between the user and a real-time tutor. The user interface 800 discloses the response generated by the AI engine 138 which is provided to the user in a text-based format, for example, chat-based. The response can be provided to the user in other formats as well, like video which is explained in detail in other figures. The response generated by the AI engine 138 is integrated within the real-time tutor to provide real-time guidance to the user. The integration of real-time tutors in the online learning platform is discussed in detail in U.S. patent application Ser. No. 19/269,565, which is incorporated by reference in its entirety.

Whenever the user faces any difficulty in understanding the concept, or the user has any doubts while studying, the user can click on the interactive button 106 to interact with the real-time tutor. Tab 802 depicts the virtual character i.e., the real-time tutor who is guiding the user using the online learning platform 102. The real-time tutor 802 is always selected in correlation to the context of the ongoing educational content provided to the user. The AI engine 138 generates an initial message 804 explaining the educational content item provided to the user with the help of the real-time tutor 802.

The user can further like or dislike the response provided by the real-time tutor 802 by clicking on the tabs 806 and 808 respectively.

Further, the user interfaces 900-1100 show the interaction between the user and the real-time tutor 802. The user after receiving the initial message 804 from the user, may interact with the user, in case the user has further doubts. For instance, the user may ask questions like ‘What else do I need to know for the exam?’ 902, ‘Wow, that is a lot of information, my memory is like a sieve. Help me memorize it’ 1002, ‘Pick your best method and turn this information into something, I can memorize right now’ 1102, and so on.

The user can ask as many questions as he/she wants which are relevant to the educational content. Also, the user can ask such questions which will provide them guidance mentioned in the user interface 900-1100.

FIG. 12 depicts an exemplary user interface 1200 displaying the front page of the practice test mode operation in an online learning platform 102.

As discussed earlier the online learning platform 102 provides two modes of operation for the user, namely, study mode (discussed in FIGS. 4-11) and test mode (FIGS. 12-16). The details of the study mode are discussed in the previous section and the details of the test mode are now discussed in detail.

The user interface 1200 displays the basic details of the tests that the user has to undergo to attain mastery in any topic or to check his/her expertise level at any level while preparing for exams like SAT, TOEFL, and so on. The user can simply click on tabs 1202 ‘Start MCQ Test’, or 1204 ‘Start FRQ Test’. Based on the selection of the user the corresponding test will open, for instance, if the user selects 1202, the Multiple-choice question test will open and if the user selects 1204, the Frequency response question test will open.

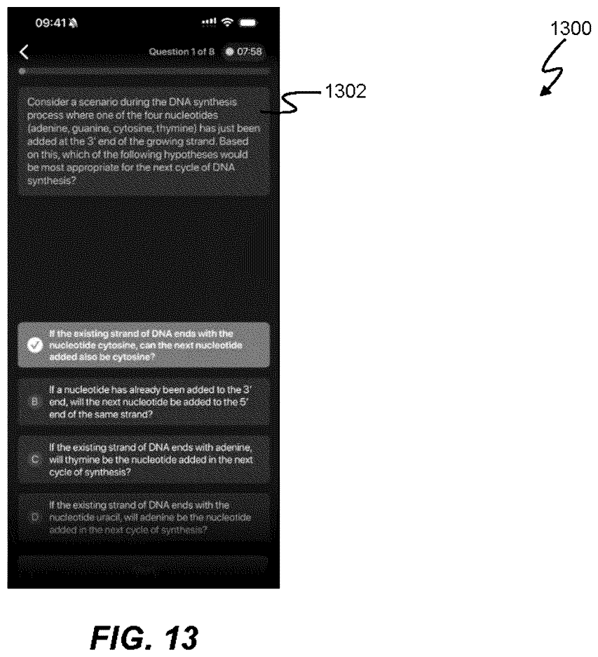

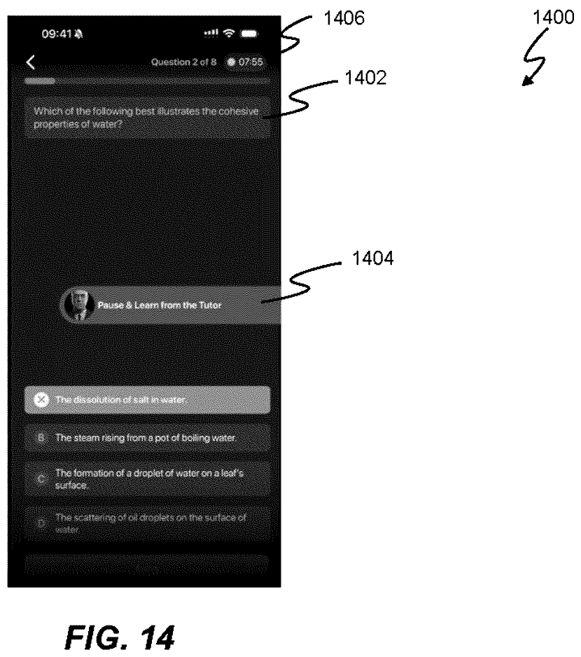

FIGS. 13 and 14 depict exemplary user interfaces 1300 and 1400 disclosing the educational content to the user where the user gives correct and incorrect answers respectively.

The user interface 1300 discloses a Multiple Choice Question 1302 since the user has selected MCQ test 1202 in the previous menu. Here, the user provides the correct answer to the question provided to the user, so the user is accordingly taken to the next question.

The user interface 1400 discloses that the user has given an incorrect answer to a Multiple Choice Question 1402 provided to the user. As soon as the user provides the incorrect answer, a pop-up 1404 arrives and the test is paused. The timer of test 1406 shown in the top right corner of the user interface 1400 pauses when the user gives the incorrect answer. During the paused time interval the user is given the chance to learn what mistakes the user has made, concepts behind the question asked, misunderstandings of the user, and so on.

The pop-up tab 1404 ‘Pause and Learn from the Tutor’ comes into existence when the user gives the incorrect answer and as soon as the user clicks on this tab, the user will be taken to a different user interface 1500, where the real-time tutor will guide the user in detail, as discussed in detail below.

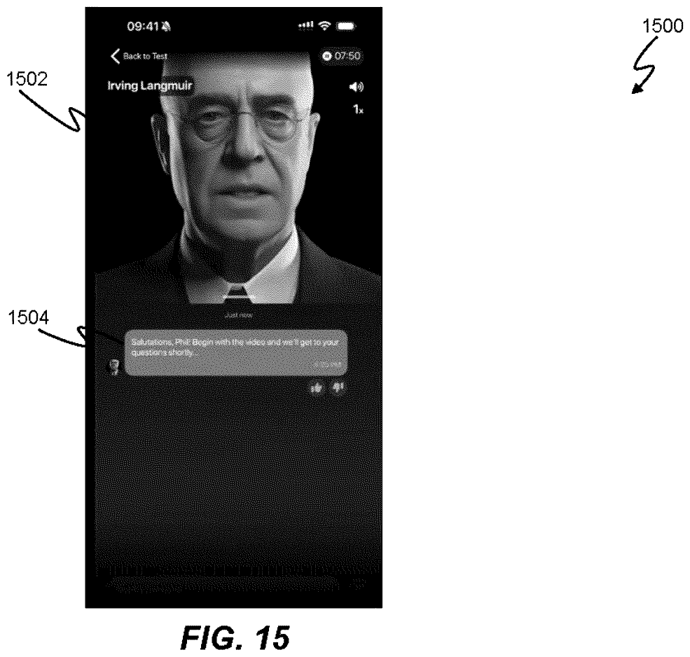

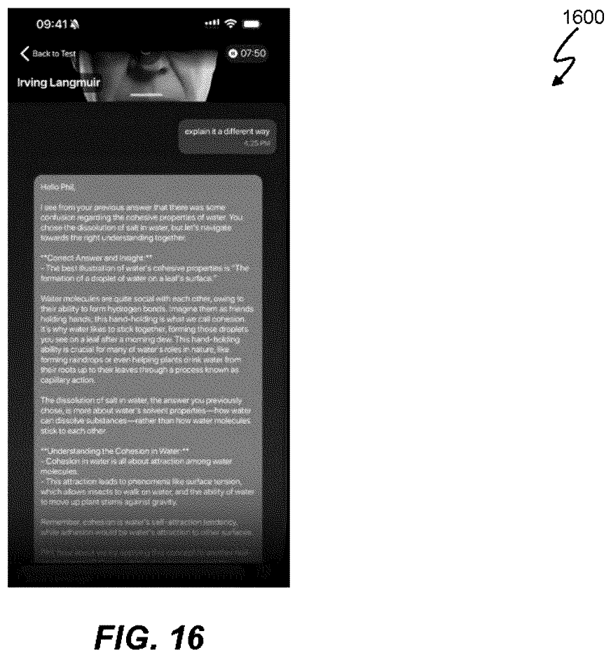

FIGS. 15 and 16 depict exemplary user interfaces 1500 and 1600 disclosing the interaction between the user and a real-time tutor 1502. After giving the wrong answer and clicking on the pop-up tab 1404 ‘Pause and Learn from the Tutor’, the user interface 1500 is displayed to the user where the real-time tutor 1502 comes up with a pre-generated video, explaining the concepts related to the question asked to the user. An initial message 1504 is provided to the user by the real-time tutor 1502, for instance, ‘Hey Peter, salutations!!, Begin with the video and we will get back to your questions shortly.’ Initially, the video is played which explains the concepts to the user. If the user further faces any difficulty, then the user can ask the questions to the user in real-time.

The user interface 1600 shows the chat interaction between the user and the real-time tutor 1502 using the chatbot 108 integrated with the user interface 104. In the present exemplary scenario, the chat-based interactions are shown, although not limited to, the user can also provide input using various other formats like audio, and video.

In this way, the user gets its doubts, and misunderstandings cleared by the real-time tutor. Further, the online learning platform 102 using such techniques provides an adaptive, engaged, and personalized learning experience to the user.

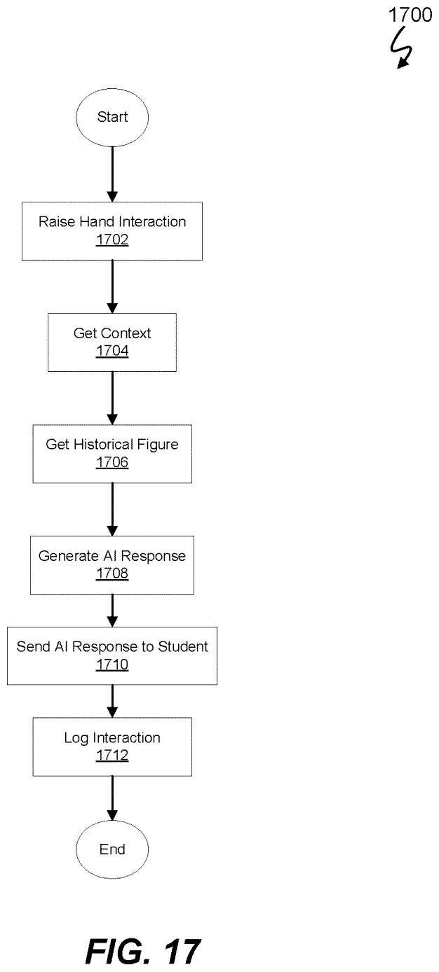

FIG. 17 depicts a response generation process 1700 for guiding the user using a real-time tutor, which is an embodiment of the user guidance process 200 using real-time tutors in an online learning platform 102 of FIG. 2. The response generation process 1700 explains guiding the student using the online learning platform 102. The response generation process 1700 begins when the student raises a hand 1702 for interaction using the interaction button 106 which indicates that the student is facing some problems in understanding the concept, is given some incorrect answers, and needs help.

The student guidance engine 126 retrieves relevant information about the student's current online learning session 1704, including the ongoing educational content. This ensures that the assistance provided is contextually accurate. Further, the virtual character or the real-time tutor is selected 1706 from the library using a virtual character selector 150 (not shown in the figure) based on the context behind the educational content provided to the student. The prompt engineer provides a structure of prompts along with the rules and guidelines for prompt generation. The prompt generator 134 fetches the analyzed data from the analyzer 132 and populates the prompt structure provided by the prompt engineer. The prompt generator 134 utilizes NLP techniques and populates prompts to be delivered to the AI engine 138 to generate the personalized and adaptive response 1708 for the student. The generated response is shared with student 1710 on the user interface 104 of the online learning platform 102.

Finally, the interaction is recorded in the form of logs 1712 and stored in the memory 110 of the online learning platform 102, ensuring that the collector 130 (not shown in the figure) keeps track of the student's queries and responses for future reference and continued learning support.

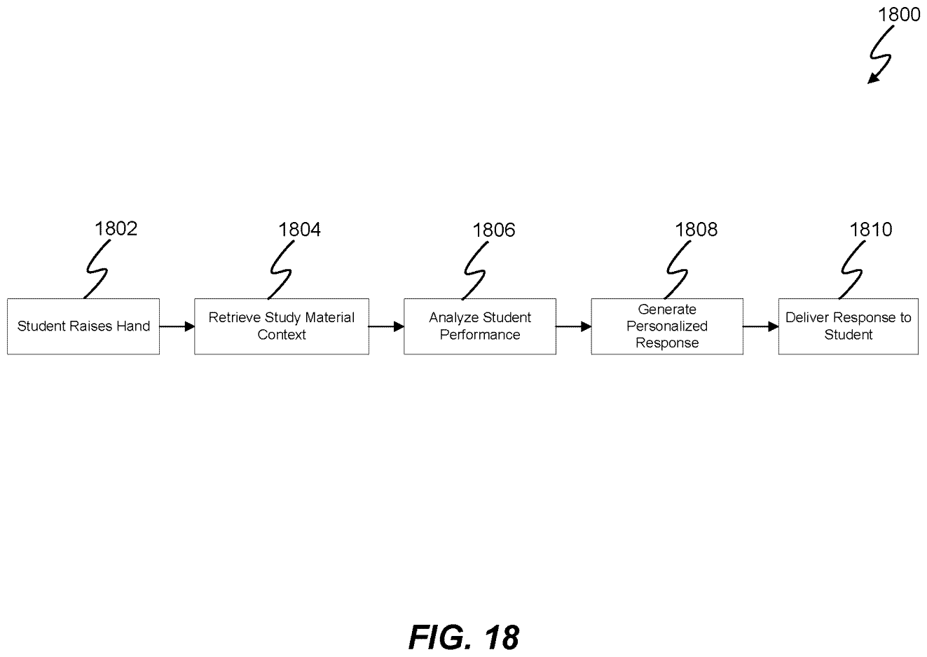

FIG. 18 depicts a personalized response generation process 1800 based on the analysis of the student's performance, which is an embodiment of the user guidance process 200 using real-time tutors in an online learning platform 102 of FIG. 2. The personalized response generation process 1800 explains guiding and assisting students in real-time. The personalized response generation process 1800 starts with the student raising hand 1802 by using the interactive button 106 (not shown in the figure), integrated within the user interface 104 of the online learning platform 102. Using this way the student signals the user guidance system 100 for help during their online learning session.

The user guidance engine 126 (not shown in the figure), operatively coupled to the online learning platform 102 retrieves the relevant context 1804 from the ongoing online learning session of the user using the collector 130 (not shown in the figure). The collector is integrated within the user guidance engine 126. This includes accessing the specific content the student is working on, and ensuring that the subsequent assistance is directly related to their current learning activities. The student's performance is then analyzed 1806 using the analyzer 132 (not shown in the figure) by analyzing the user's performance data 114, including the user's past interaction data 116 with the online learning platform 102, responses, and progress. This analysis helps identify areas where the student may be struggling or concepts they have not fully grasped. This personalized insight is crucial for generating responses that are in correlation to the individual student's needs.

The AI engine 138 (not shown in the figure) generates the personalized response 1806 to address the student's specific misunderstandings, provide clarifications, and offer guidance that aligns with their current learning objectives. Finally, the generated response is delivered to student 1810 and is displayed on the user interface 104 of the online learning platform 102. The student can further interact with the real-time tutor in case of any further doubts. The entire personalized response generation process 1800 is designed to be efficient and responsive, enhancing the student's learning experience through real-time, adaptive assistance.

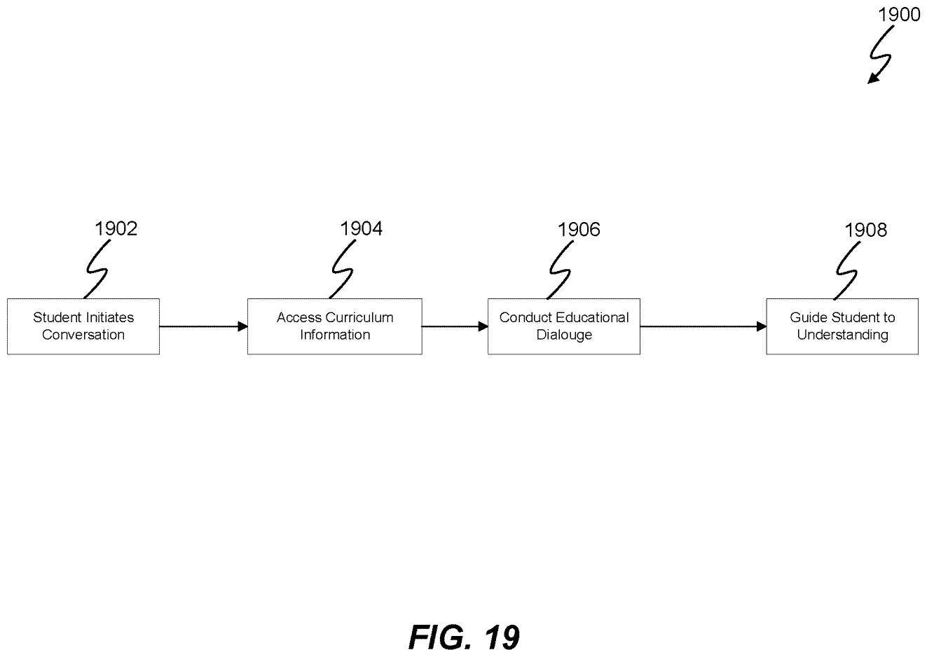

FIG. 19 depicts a student and real-time tutor interaction process 1900, which is an embodiment of the user guidance process 200 using real-time tutors in an online learning platform 102 of FIG. 2. The student and real-time tutor interaction process 1900 guides the student using the online learning platform 102 through interaction between the user and the real-time tutor. The student and real-time tutor interaction process 1900 begins with the student initiating the online learning platform 102, then the student starts an interaction 1902 with the AI engine 138 (not shown in the figure). During the interaction of the user with the online learning platform 102, the user directly interacts with the AI-generated real-time tutor and asks questions or seeks clarification on a topic.

After initializing the communication between the user and the online learning platform 102, the AI engine 138 (not shown in the figure) accesses 1904 the educational database 122, and retrieves relevant educational content and contextual information from the educational database 122. Further, the student is provided with an educational pre-generated video from the real-time tutor 1906. This video is designed to be interactive and responsive, adapting to the student's needs and promoting engaging learning.

Finally, the student is guided by the real-time tutor 1908 which helps the student to achieve a deeper understanding of the educational content. Through targeted responses and explanations, the AI engine 138 aims to clarify concepts, correct misunderstandings, and reinforce learning objectives and hence ensure that the student not only receives answers but also builds a solid grasp of the educational content, enhancing their overall educational experience.

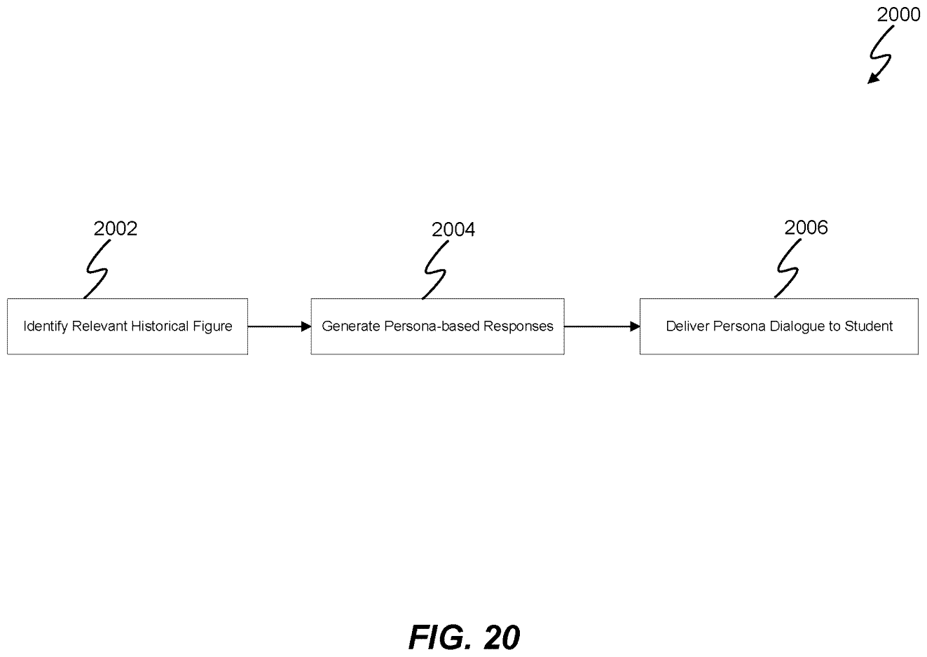

FIG. 20 depicts a response delivery process 2000, which is an embodiment of the user guidance process 200 using real-time tutors in an online learning platform 102 of FIG. 2.

The response delivery process 2000 explains the integration of the historical persona or virtual characters which act as real-time tutors in the online learning process. The process starts with the identification of the relevant historical persona 2002, which involves selecting a historical figure in correlation to the current educational content. This selection is based on the subject matter and the learning objectives, ensuring that the chosen persona is both educationally relevant and engaging for the student.

Once the relevant historical figure is identified 2002, the response is generated for the historical persona 2004 using the AI engine 138 (not shown in the figure). The response generated by the AI engine 138 is integrated into the historic persona i.e. the real-time tutor. The generated responses are not only informative but also integrated with the distinctive voice and face of the historical figure, making the learning experience richer and more engaging. Finally, the generated response is delivered to the user 2006 to guide the user and enhance the learning process.

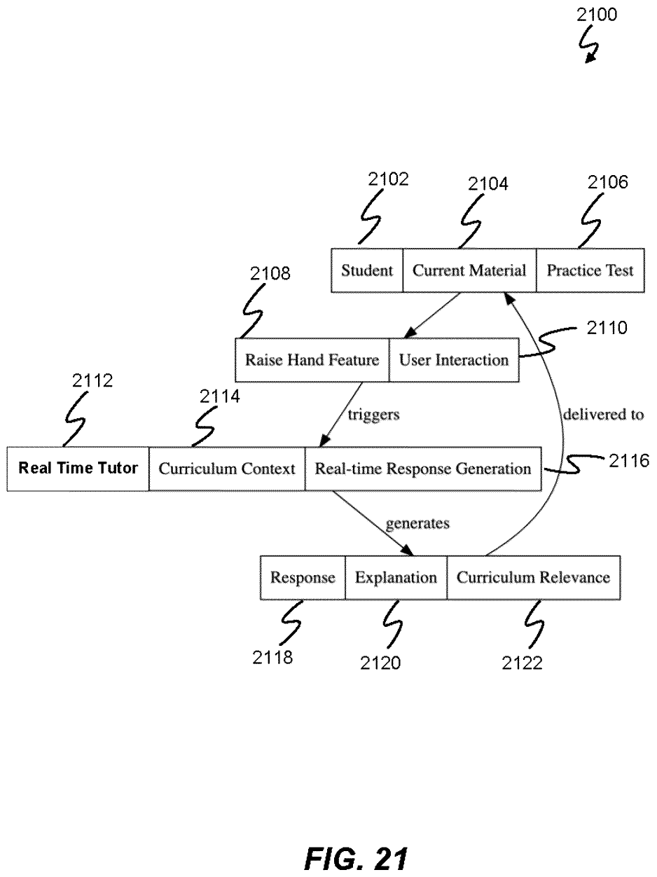

FIG. 21 depicts a data structure 2100 for organizing data to provide real-time, in-context, and personalized educational guidance to the user using an online learning platform 102.

The data structure 2100 for organizing data to provide real-time, in-context, and personalized educational guidance to the user using an online learning platform 102 includes four primary entities namely, Student node 2102, RaiseHandFeature node 2108, real-time tutor node 2110, and Response node 2116.

The data structure 2100 includes a Student node 2102, which captures the user's engagement with the learning material. The Student node 2102 is further divided into fields such as Current Material 2104 and Practice Test 2106, indicating that the Student node 2102 holds information about what the student is currently studying during the ongoing online learning session and any practice tests they are undertaking. The Student node 2102 is connected to the RaiseHandFeature node 2108, signifying that the student interacts with the real-time tutor using the interactive button 106 when they need assistance or guidance. The RaiseHandFeature node 2108 represents the mechanism through which the student requests help. This feature captures user interaction data 116 and serves as a trigger for the subsequent steps in the process.

Upon activation of the RaiseHandFeature, a connection is made to the real-time tutor node 2110. This edge, labeled triggers, indicates that the raise hand action initiates the real-time tutor's engagement. The real-time tutor node is a critical component containing fields such as Curriculum Context 2112 and Real-time Response Generation 2114. These fields suggest that the real-time tutor utilizes contextual information from the educational database 122 to generate responses in correlation to the student's immediate needs.

The real-time tutor node 2110, then generates a Response 2116, as indicated by the generated edge connecting these two nodes. The Response node 2116 is where the real-time tutor's output is captured. The Response node 2116 is structured with fields like Explanation 2118 and Curriculum Relevance 2120, highlighting that the response is not only explanatory but also directly relevant to the educational database 122 followed by the student. Finally, the response is delivered back to the Student node 2102, completing the interaction loop. This is depicted by the edge labeled delivered to, which connects the Response node 2116 back to the Student node 2102. This closed-loop ensures that the student receives immediate, personalized feedback, thus enhancing their learning experience.

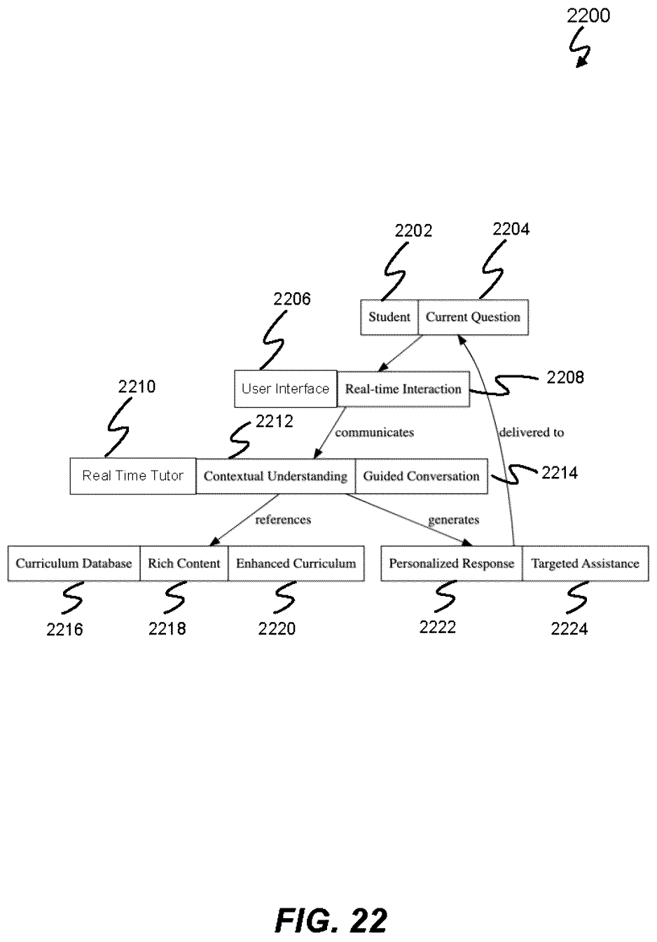

FIG. 22 depicts a data structure 2200 for organizing data to allow real-time interaction between a user and a real-time tutor. The data structure 2200 for organizing data to allow real-time interaction between a user and a real-time tutor includes five primary entities namely, Student node 2202, User Interface node 2206, a real-time tutor node 2210, an Educational Database node, and Personalized response node 2222.

The data structure 2200 includes a Student node 2202, which represents the engagement of the user with the online learning platform 102 during the online learning session. The Student node 2202 is detailed with fields such as Current Question 2204, indicating the specific query or problem the student is addressing at any given moment during the online learning session. The Student node 2202 connects to the User Interface node 2206, illustrating that the student uses the user interface 104 to interact with the real-time tutor via, interactive buttons 106, and chatbot 108. The User interface node 2206 is characterized by its capacity for Real-time Interaction 2208, emphasizing its role in facilitating immediate and seamless communication between the student and the online learning platform 102 (not shown in the figure).

The student then interacts with the Real-time tutor node 2210, denoted by the connection indicating communication between the User interface node 2206 and the Real-time tutor 2210. The Real-time tutor node 2210 is crucial for interpreting the student's questions and possesses fields like Contextual Understanding 2212 and Guided Conversation 2214, highlighting its ability to understand the student's needs and guide the interaction in a meaningful way. To generate accurate and contextually appropriate responses, the real-time tutor references the Educational database node 2216 which contains fields such as Rich Content 2218 and Enhanced Educational database 2220, indicating that it provides detailed and enriched educational content items that is provided to the student whenever the student needs guidance.

Upon referencing the Educational database 2216, the AI engine 138 (not shown in the figure) generates a Personalized Response 2222, which is in correlation to the student's request. The node for Personalized Response 2222 includes fields like Targeted Assistance 2224, underscoring that the responses are specifically crafted to address the student's individual needs and enhance their understanding of the subject matter. Finally, the Personalized Response 2222 is delivered back to the Student node 2202, closing the interaction loop. This connection ensures that the student receives the guidance generated by the AI engine 138, thereby completing the feedback cycle and providing the necessary assistance to aid their learning process.

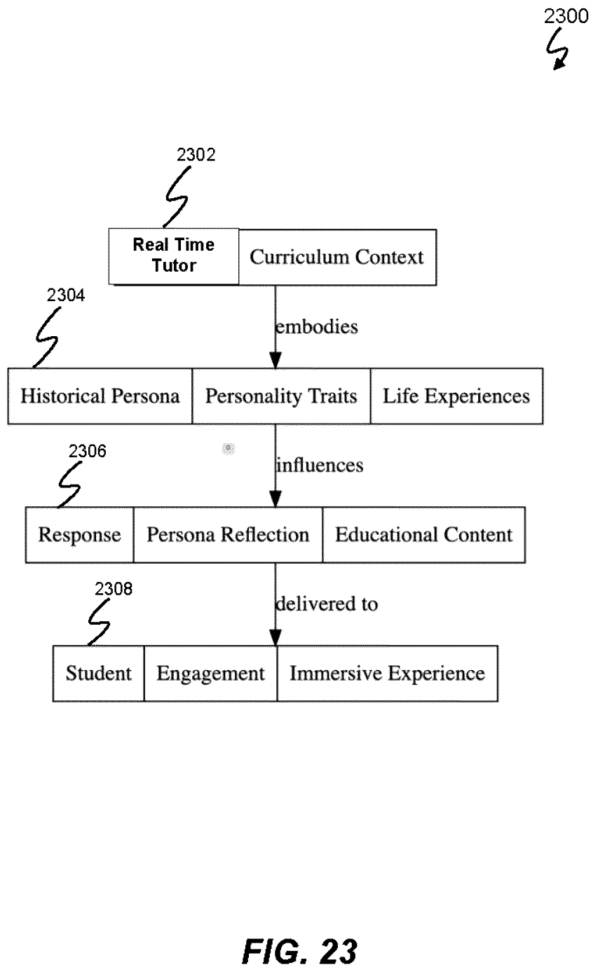

FIG. 23 depicts a data structure for organizing data to generate a response and provide it to the user through a real-time tutor. The data structure 2300 includes four entities namely, a real-time tutor node 2302, Historical persona node 2304, a Generated Response node 2306, and a Student node 2308.

The data structure 2300 focuses on the interaction between the real-time tutor and the student in the online learning platform 102, utilizing the role of historical personas i.e., the artificial intelligence-generated virtual characters who act as real-time tutors to guide the students. The real-time tutor node 2302 is central, encompassing educational content and guiding the learning process. This real-time tutor embodies a Historical Persona 2304, which includes detailed personality traits and life experiences of a notable historical figure.

The Response node 2306 generates the educational content for the user integrated into the real-time tutor node 2302 based on the user details, educational database 122, and historical database 124 i.e., where the information of the historic persona is stored. This response is then delivered to the Student node 2308, providing an engaging and immersive learning experience. The student benefits from the combination of educational content and the enriched narrative provided by the historical persona, enhancing both engagement and understanding.

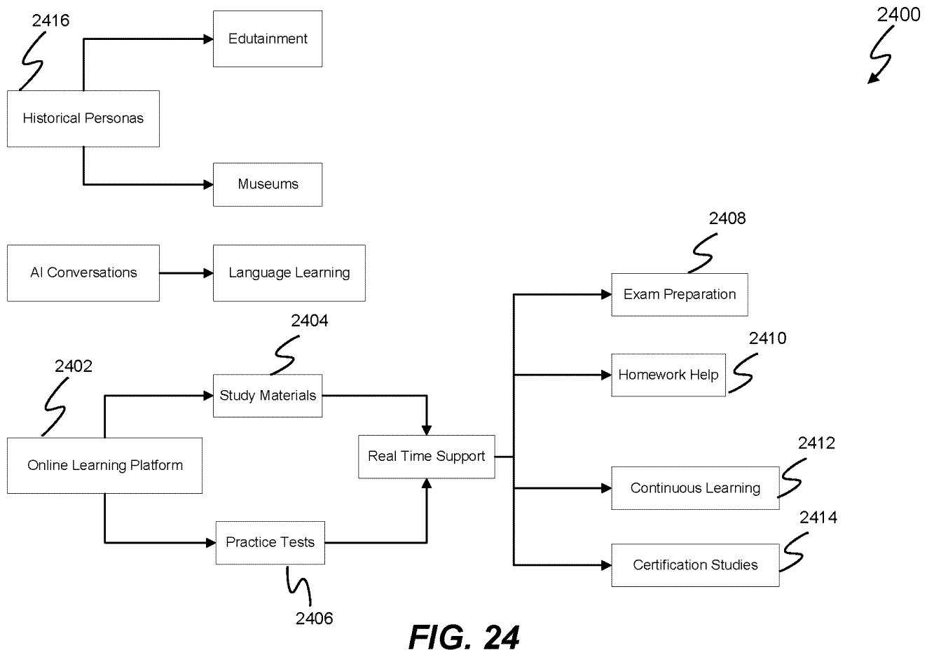

FIG. 24 depicts a data structure for organizing data to disclose the application areas of the user guidance system 100 using real-time tutors. The data structure 2400 includes the Online Learning Platform node 2402, serving as the hub for accessing all educational content. The online learning platform 102 directly connects to Study Materials 2204 and Practice Tests 2206, providing students with educational content and opportunities to assess their understanding and prepare for exams. Study Materials 2204 and Practice Tests 2206 feed into AI engine 138, a crucial feature that offers immediate, personalized assistance to students using real-time tutors. When the student engages with study materials 2204 or practice tests 2206, they can access real-time guidance from the real-time tutor. This support is instrumental in several key areas like Exam Preparation 2208, where students receive targeted help to enhance their readiness for exams; Homework Help 2210, offering assistance with specific assignments; Continuous Learning 2212, nurturing ongoing educational development; and Certification Studies 2214, supporting learners pursuing professional qualifications.

The online learning platform 102 also includes interactions between the user and the real-time tutor to provide guidance and help to the user whenever needed. Moreover, the inclusion of Historical Personas 2416 adds a unique and engaging element to the educational experience. By incorporating AI-generated virtual characters like historical figures, the online learning platform 102 enhances Edutainment, making learning more enjoyable and immersive.

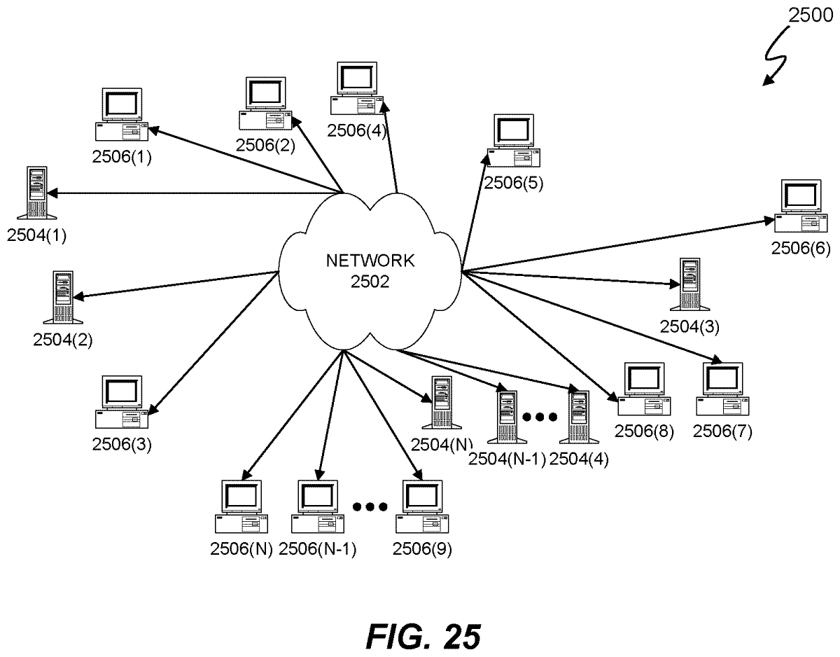

FIG. 25 is a block diagram illustrating a network environment in which a user guidance system 100 and process 200 using the real-time tutor may be practiced. Network 2502 (e.g. a private wide area network (WAN) or the Internet) includes several networked server computer systems 2504(1)-(N) that are accessible by client computer systems 2506(1)-(N), where N is the number of server computer systems connected to the network. Communication between client computer systems 2506(1)-(N) and server computer systems 2504(1)-(N) typically occurs over a network, such as a public switched telephone network over asynchronous digital subscriber line (ADSL) telephone lines or high-bandwidth trunks, for example, communications channels providing T1 or OC3 service. Client computer systems 2506(1)-(N) typically access server computer systems 2504(1)-(N) through a service provider, such as an internet service provider (“ISP”) by executing application-specific software, commonly referred to as a browser, on one of client computer systems 2506(1)-(N).

Client computer systems 2506(1)-(N) and server computer systems 2504(1)-(N) are specialized computers programmed to improve conventional computer systems to implement and utilize the user guidance system 100 and process 200 using the real-time tutor. The type of computer system that can be specially programmed to implement and utilize the user guidance system 100 and process 200 using the real-time tutor includes a mainframe, a mini-computer, a personal computer system including notebook computers, a wireless, mobile computing device (including personal digital assistants, smartphones, and tablet computers). These computer systems are typically designed to provide computing power to one or more users locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the user guidance system 100 and process 200 using the real-time tutor can be implemented using code stored in a tangible, non-transient computer-readable medium and executed by one or more processors. In at least one embodiment, the user guidance system 100 and process 200 using the real-time tutor can be implemented completely in hardware using, for example, logic circuits and other circuits including field programmable gate arrays.

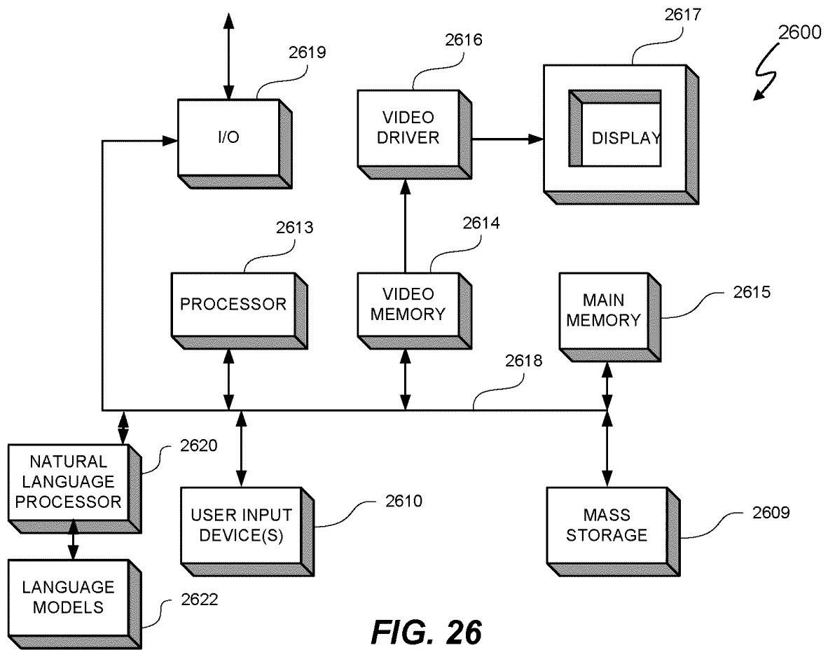

Embodiments of the user guidance system 100 and process 200 using the real-time tutor can be implemented on a computer system such as a special-purpose, special-programmed computer 2600 illustrated in FIG. 26. Input user device(s) 2610, such as a keyboard and/or mouse, are coupled to a bi-directional system bus 2618. The input user device(s) 2610 are for introducing user input to the computer system and communicating that user input to processor 2613. The computer system of FIG. 26 generally also includes a non-transitory video memory Y14, non-transitory main memory 2615, and non-transitory mass storage 2609, all coupled to bi-directional system bus 2618 along with input user device(s) 2610 and processor 2613. The mass storage 2609 may include fixed and removable media, such as a hard drive, one or more CDs or DVDs, solid state memory including flash memory, and other available mass storage technology. Bus 2618 may contain, for example, 32 of 64 address lines for addressing video memory 2614 or main memory 2615. The system bus 2618 also includes, for example, an n-bit data bus for transferring DATA between and among the components, such as CPU 2609, main memory 2615, video memory 2614, and mass storage 2609, where “n” is, for example, 32 or 64. Alternatively, multiplex data/address lines may be used instead of separate data and address lines.

I/O device(s) 2619 may provide connections to peripheral devices, such as a printer, and may also provide a direct connection to a remote server computer system via a telephone link or to the Internet via an ISP. I/O device(s) 2619 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 2609, into main memory 2615 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 2613, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 2615 consists of dynamic random access memory (DRAM). Video memory 2614 is a dual-ported video random access memory. One port of the video memory 2614 is coupled to the video amplifier 2616. The video amplifier 2616 is used to drive the display 2617. Video amplifier 2616 is well-known in the art and may be implemented by any suitable means. This circuitry converts pixel DATA stored in video memory 2614 to a raster signal suitable for use by display 2617. Display 2617 is a type of monitor suitable for displaying graphic images.

The computer system described above is for purposes of example only. The user guidance system 100 and process 200 using the real-time tutor may be implemented in any type of computer system programming or processing environment. It is contemplated that the user guidance system 100 and process 200 using the real-time tutor might be run on a stand-alone computer system, such as the one described above. The real-time tutor generation system 100 and process 200 using Artificial Intelligence for adaptive learning might also be run from a server computer systems system that can be accessed by a plurality of client computer systems interconnected over an intranet network. Finally, the user guidance system 100 and process 200 using the real-time tutor may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method of guiding and constraining an artificial intelligence (AI) engine to allow a virtual character to interact with a user using an online learning platform for guiding the user, the method comprises:
executing code using one or more processors of a computer system to cause the computer system to perform operations comprising:
receiving a request from the user asking for guidance during an online learning session, or in between the practice tests;
accessing user profile and educational database to fetch the details of the user and educational content items, wherein the user details include details of the 9 ongoing and past online learning sessions, user performance data, and user interaction data with the online learning platform;
generating a prompt to guide and constrain the AI engine for guiding the user based on a context of the ongoing learning session, user interactions with the online learning platform, and user performance data;
transferring the generated prompt to the AI engine; and
receiving a detailed and personalized response from the AI engine, wherein the response explains educational concepts, corrects any user misunderstanding of the educational concepts, and guides the user in correlation with the educational database.

2. The method of claim 1 wherein the virtual character is an Artificial Intelligence (AI) generated real-time tutor guiding the user whenever the user faces difficulty in understanding the educational content, or when the user answers the test questions incorrectly.

3. The method of claim 1 wherein the generated real-time tutor is the famous virtual character and in correlation to the context of the educational content item displayed to the user.

4. The method of claim 1 wherein the education database includes a plurality of educational content items categorized by standard, topic, and difficulty level.

5. The method of claim 1 wherein the user can initiate a real-time interaction with the real-time tutor by asking questions in context to the ongoing online learning session.

6. The method of claim 1 further comprises:
receiving the user input in multiple formats while interacting with the real-time tutor, including text, audio, and video;
utilizing NLP (Natural Language Processing) techniques to interpret user inputs and extracting semantic meaning and contextual information from the user input;
employing an emotion and gesture recognition algorithm to analyze the user's tone of voice, physical gestures, and emotional state, identifying non-verbal cues that provide additional context to the user inputs and interactions.

7. The method of claim 1 wherein the AI engine generates the personalized response using machine learning algorithms which utilizes the real-time tutor to present the response in various formats, including text, audio, and video.

8. The method of claim 7 further comprises:
training a machine learning model on historical data and scripted content to capture the personality, language style, and knowledge of the virtual character;
utilizing the trained machine learning model to generate a response that is accurate and in correlation with the educational database;
combining the results generated by the AI engine and the trained machine learning model to generate an accurate response in correlation with the educational database and the ongoing online learning session.

9. The method of claim 1 wherein the interpretation of the user's request is performed by the AI engine by utilizing NLP techniques comprises:
interpreting the user's input by analyzing the syntax, semantics, and context of the input to understand the user's intent and specific needs;
generating a response that addresses the user's request, ensuring clarity and relevance.

10. The method of claim 1 further comprises:
continuously monitoring and accessing the user's performance data and user's interaction data to refine the real-time tutor response to meet the user's requirement;
establishing a feedback loop where user's feedback and reactions are used to improve the generated prompt and generated content, ensuring continuous improvement and adaptation of the learning experience.

11. The method of claim 1 wherein the user can provide feedback on their interaction with the real-time tutor, including ratings, comments, and additional questions.

12. A system to guide and constrain an artificial intelligence (AI) engine enables a virtual character to interact with a user using an online learning platform for assisting in educating the user, the system comprising:
one or more processors; and
a memory, coupled to the one or more processors, that stores code that when executed causes the one or more processors to perform operations comprising:
receiving a request from the user asking for guidance during an online learning session, or in between the practice tests using an interactive button integrated within a user interface of the online learning platform;
accessing user profile and educational database to fetch the details of the user and educational content items using a collector, wherein the user details include details of the ongoing and past online learning sessions, user performance data, and user interaction data with the online learning platform;
generating a prompt using a prompt generator to guide and constrain the AI engine for guiding the user based on the context of the ongoing learning session, user interactions with the online learning platform, and user performance data;
transferring the prompt generated by the prompt generator to the AI engine to guide the user; and
receiving a detailed and personalized response from the AI engine, wherein the response explains educational concepts, corrects any user misunderstanding of the educational concepts, and guides the user in correlation with the educational database.

13. The system of claim 12 wherein the user interface is integrated within the online learning platform and the generated detailed and personalized response from the AI engine is displayed to the user via the user interface.

14. The system of claim 12 wherein the interactive buttons allow users to interact with the real-time tutor directly whenever they need guidance or face difficulty in understanding the concept.

15. The system of claim 12 further comprises:
the collector to access and fetch the user interaction data with the online learning platform;
an analyzer to analyze the user interaction data to identify user behavior patterns, learning difficulties, and areas that require improvement;
the prompt generator to generate the prompt using the identified user behavior patterns, learning difficulties, and areas that require improvement.

16. The system of claim 12 wherein the user interface offers customizable interaction options to the user, includes conceptual explanations, problem-solving strategies, test preparations, or how to memorize the concept easily.

17. The system of claim 12 wherein the AI engine utilizes a trained machine learning model that utilizes the data from the educational database, user's queries, user's ongoing and past interaction with the online learning platform, and user's performance data.

18. The system of claim 12 wherein the user can provide feedback responses on their interaction with the real-time tutor using a feedback module, that includes ratings, comments, and additional questions.
